SEQUENCE LISTING (40 sequences)

SEQ ID NO: 1 - DNA, 20 bp, Artificial
  forward primer 16sfD1Cy3
agagtttgatcctggctcag

SEQ ID NO: 2 - DNA, 27 bp, Artificial
  reverse primer
taccgtcaccataaggcttcgtcccta

SEQ ID NO: 3 - DNA, 18 bp, Artificial
  amino-modified oligonucleotide
gtttcccaggcttatccc

SEQ ID NO: 4 - DNA, 52 bp, Artificial
  primer uniA_cyp2D6_1/2f
ggagcacgctatcccgttagaccagaggagcccatttggtagtgaggcaggt

SEQ ID NO: 5 - DNA, 45 bp, Artificial
  primer uniA_cyp2D6_1/2f_F2
ggagcacgctatcccgttagactggacgccggtggtcgtgctcaa

SEQ ID NO: 6 - DNA, 43 bp, Artificial
  primer uniA_cyp2D6_3/4f
ggagcacgctatcccgttagaccacgcgcacgtgcccgtccca

SEQ ID NO: 7 - DNA, 45 bp, Artificial
  primer uniA_cyp2D6_5/6f_kF
ggagcacgctatcccgttagaccgctggctggcaaggtcctacgc

SEQ ID NO: 8 - DNA, 41 bp, Artificial
  primer uniA_cyp2D6_8/9f_kF
ggagcacgctatcccgttagacgccccggcccagccaccat

SEQ ID NO: 9 - DNA, 45 bp, Artificial
  uniB_cyp2D6_1/2r
cgctgccaactaccgcacatgggtcccacggaaatctgtctctgt

SEQ ID NO: 10 - DNA, 44 bp, Artificial
  primer uniB_cyp2D6_1/2r_F1
cgctgccaactaccgcacatgcctctgccgccctccaggacctc

SEQ ID NO: 11 - DNA, 45 bp, Artificial
  primer uniB_cyp2D6_3/4r
cgctgccaactaccgcacatgctctcgctccgcacctcgcgcaga

SEQ ID NO: 12 - DNA, 48 bp, Artificial
  primer uniB_cyp2D6_5/6r
cgctgccaactaccgcacatgccctcggcccctgcactgtttcccaga

SEQ ID NO: 13 - DNA, 45 bp, Artificial
  primer uniB_cyp2D6_8/9r_kF
cgctgccaactaccgcacatgtggctagggagcaggctggggact

SEQ ID NO: 14 - DNA, 22 bp, Artificial
  universal forward primer uniB
ggagcacgctatcccgttagac

SEQ ID NO: 15 - DNA, 21 bp, Artificial
  universal reverse primer uniA
cgctgccaactaccgcacatg

SEQ ID NO: 16 - DNA, 27 bp, Artificial
  oligonucleotide C2938T
aatgatgagaacctgtgcatagtggtg

SEQ ID NO: 17 - DNA, 27 bp, Artificial
  oligonucleotide C2938 WT
aatgatgagaacctgcgcatagtggtg

SEQ ID NO: 18 - DNA, 20 bp, Artificial
  structure breaker C2938TBL3
ggctgacctgttctctgccg

SEQ ID NO: 19 - DNA, 20 bp, Artificial
  structure breaker C2938TBL5
ggaaccctgagagcagcttc

SEQ ID NO: 20 - DNA, 27 bp, Artificial
  oligonucleotide probe C2938T
aatgatgagaacctgtgcatagtggtg

SEQ ID NO: 21 - DNA, 28 bp, Artificial
  oligonucleotide probe C2938TC
aatgatgagaacctgtcgcatagtggtg

SEQ ID NO: 22 - DNA, 28 bp, Artificial
  oligonucleotide probe C2938GT
aatgatgagaacctggtgcatagtggtg

SEQ ID NO: 23 - DNA, 29 bp, Artificial
  oligonucleotide probe C2938GTC
aatgatgagaacctggtcgcatagtggtg

SEQ ID NO: 24 - DNA, 27 bp, Artificial
  oligonucleotide probe C2938G
aatgatgagaacctgggcatagtggtg

SEQ ID NO: 25 - DNA, 28 bp, Artificial
  oligonucleotide probe C2938GC
aatgatgagaacctggcgcatagtggtg

SEQ ID NO: 26 - DNA, 26 bp, Artificial
  oligonucleotide probe C2938d
aatgatgagaacctggcatagtggtg

SEQ ID NO: 27 - DNA, 28 bp, Artificial
  oligonucleotide probe C2938CT
aatgatgagaacctgctgcatagtggtg

SEQ ID NO: 28 - DNA, 29 bp, Artificial
  oligonucleotide probe C2938CTC
aatgatgagaacctgctcgcatagtggtg

SEQ ID NO: 29 - DNA, 27 bp, Artificial
  oligonucleotide probe C2938
aatgatgagaacctgcgcatagtggtg

SEQ ID NO: 30 - DNA, 28 bp, Artificial
  oligonucleotide probe C2938CC
aatgatgagaacctgccgcatagtggtg

SEQ ID NO: 31 - DNA, 28 bp, Artificial
  oligonucleotide probe C2938AT
aatgatgagaacctgatgcatagtggtg

SEQ ID NO: 32 - DNA, 29 bp, Artificial
  oligonucleotide probe C2938ATC
aatgatgagaacctgatcgcatagtggtg

SEQ ID NO: 33 - DNA, 27 bp, Artificial
  oligonucleotide probe C2938A
aatgatgagaacctgagcatagtggtg

SEQ ID NO: 34 - DNA, 28 bp, Artificial
  oligonucleotide probe C2938AC
aatgatgagaacctgacgcatagtggtg

SEQ ID NO: 35 - DNA, 26 bp, Artificial
  forward primer cyp2D6_5/6f
ggactctgtacctcctatccacgtca

SEQ ID NO: 36 - DNA, 26 bp, Artificial
  competitor cyp2D6_5/6f_3NH2
ggactctgtacctcctatccacgtca

SEQ ID NO: 37 - DNA, 27 bp, Artificial
  reverse primer cyp2D6_5/6r_5Cy3
ccctcggcccctgcactgtttcccaga

SEQ ID NO: 38 - DNA, 19 bp, Artificial
  oligonucleotide (insertion probe)
gtttcccagggcttatccc

SEQ ID NO: 39 - DNA, 17 bp, Artificial
  oligonucleotide (deletion probe)
gtttcccagcttatccc

SEQ ID NO: 40 - DNA, 18 bp, Artificial
  oligonucleotide (match probe)
gtttcccaggcttatccc

(19) United States
(12) Patent Application Publication
(10) Pub. No.: US 2006/0147996 A1
(43) Pub. Date: Jul. 6, 2006

(54) Device for holding and detecting substance libraries

(75) Inventors: Thomas Ullrich, Jena (DE); Torsten Schulz, Jena (DE); Thomas Ellinger, Jena (DE); Siegfried Poser, Jena (DE); Eugen Ermantraut, Jena (DE); Ralf Ehricht, Jena (DE)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Clondiag Chip Technologies GmbH, Jena (DE)

(21) Appl. No.: 11/284,469

(22) Filed: Nov. 22, 2005

Related U.S. Application Data
(63) Continuation of application No. PCT/EP04/05576, filed on May 24, 2004.

(30) Foreign Application Priority Data
May 22, 2003 (DE) 103 23 197.8

(51) Int. Cl. C40B 40/10; C40B 50/02

(52) U.S. Cl. 435/7.1; 435/287.1

(57) ABSTRACT

The invention relates to a holding device for substance libraries which can be used, more particularly, for the detection of target molecules with the aid of substance libraries. Said device comprises: (i) a holder for a substance library carrier; (ii) a substance library carrier, which can be fixed to the holder; and (iii) a detection area applied to the substance library carrier, whereon a substance library is immobilized; and wherein at least one substance library carrier can be introduced into a laboratory reaction vessel.

### CROSS-REFERENCE TO RELATED APPLICATIONS

The present application is a continuation of International Application PCT/EP2004/005576, filed May 24, 2004, published in German, and which claims priority from German Application No. 103 23 197.8, filed May 22, 2003. The disclosures of said applications are incorporated by reference herein.

### BACKGROUND OF THE INVENTION

The invention relates to devices for holding and detecting substance libraries.

Biomedical tests are often based on the detection of an interaction between a molecule, which is present in known amount and position (the molecular probe), and an unknown molecule to be detected or unknown molecules to be detected (the molecular target molecules). In modern tests, probes are deposited in the form of a substance library on carriers, the so-called microarrays or chips, so that a sample can be analyzed simultaneously at various probes in a parallel manner (Lockhart et al. (2000) Nature, 405, 827-836). Herein, the probes are usually immobilized on a suitable matrix, as for example described in WO 00/12575 (see for example U.S. Pat. No. 5,412,087, WO 98/36827), or synthetically produced (see for example U.S. Pat. No. 5,143,854) in a predetermined manner for the preparation of the microarrays.

Detection of an Interaction Between Probe and Target Molecule is Performed as Follows:

In a predetermined manner, the probe or the probes are fixed to a certain matrix in form of a microarray. The targets are then contacted with the probes in a solution and are incubated under defined conditions. As a result of the incubation, a specific interaction occurs between probe and target. The binding occurring herein is significantly more stable than the binding of target molecules to probes, which are not specific for the target molecule. In order to remove target molecules, which have not specifically been bound, the system is washed with appropriate solutions or is heated.

The detection of the specific interaction between a target and its probe can be performed by means of a variety of methods, which normally depend on the type of the marker, which has been inserted into the target molecules before, during or after the interaction of the target molecules with the probes. Typically, such markers are fluorescent groups, so that specific target/probe interactions can be read out by fluorescence-optical methods with high local resolution and, compared to other conventional detection methods (in particular mass-sensitive methods) with low effort (Marshall et al. (1998) Nature Biotechnology, 16, 27-31; Ramsay (1998) Nature Biotechnology, 16, 40-44).

Depending on the substance library immobilized on the microarray and the chemical nature of the target molecules, interactions between nucleic acids and nucleic acids, between proteins and proteins, and between nucleic acids and proteins can be examined by means of this test principle (for review see F. Lottspeich et al, (1998), Bioanalytik, Spektrum Akademischer Verlag, Heidelberg Berlin, Germany).

Herein, antibody libraries, receptor libraries, peptide libraries, and nucleic acid libraries are considered as substance libraries, which can be immobilized as probes on microarrays or chips. The nucleic acid libraries play by far the most important role.

These are microarrays, whereon deoxyribonucleic acid (DNA) molecules, ribonucleic acid (RNA) molecules, or molecules of nucleic acid analogs (for example PNA) are immobilized. It is a prerequisite for the binding of a target molecule (DNA molecule or RNA molecule) labeled with a fluorescence group to a nucleic acid probe of the microarray that both target molecule and probe molecule are present in the form of a single-stranded nucleic acid.

An efficient and specific hybridization can only take place between such molecules. Single-stranded nucleic acid target and nucleic acid probe molecules are normally obtained by means of heat denaturation and optimal selection of parameters (temperature, ionic strength, concentration of helix-destabilizing molecules), which ensures that only probes having sequences of almost perfect complementarity (closely matching one another) remain paired with the target sequence (Leitch et al, In vitro Hybridisierung, Spektrum Akademischer Verlag, Heidelberg Berlin Oxford).

A typical example for the use of microarrays in biological test methods is the detection of microorganisms in samples in biomedical diagnostics. Herein, it is taken advantage of the fact that the genes for ribosomal RNA (rRNA) are dispersed ubiquitously and have sequence portions, which are characteristic for the respective species. Said species-characteristic sequences are applied to a microarray in the form of single-stranded DNA oligonucleotide probes. The target DNA molecules to be examined are first isolated from the sample to be examined and are equipped with fluorescence markers. Subsequently, the labeled target DNA molecules are incubated in a solution together with the probes applied to the microarray; unspecifically occurring interactions are removed by means of appropriate washing steps and specific interactions are detected by means of fluorescence-optical evaluation. In this manner, it is possible to simultaneously detect, for example, various microorganisms in a sample by means of one single test. In this test method, the number of detectable microorganisms theoretically only depends on the number of specific probes, which have been applied to the microarray.

A further example for a use in a medical test method is the generation of a single nucleotide polymorphism (short: SNP) profile as starting point for an individualized therapy.

The entirety of the genetic information of a creature is individual in all creatures, with the exception of identical (multiple) twins and clones. Herein, the extent of dissimilarity increases as the degree of biological relationship among the individuals decreases. Here, the so-called single nucleotide polymorphisms (SNPs) are the most common variation in the human genome. On the basis of the respective SNP profile of a human, it shall now become possible to assess which individual responds to the respective medicaments or which individual is likely to exhibit unwanted side effects in medicinal therapy. Data from the field of oncology show that often only 20 to 30% of the patients respond to specific active agents. The remaining 70% are often unable to utilize them, apparently due to genetic reasons. Herein, test systems based on DNA arrays are helpful in making decisions and represent an excellent method for testing the patient quickly and reliably and by means of only a few simple steps for few SNPs exclusively relevant for a disease. Thereby, therapies for patients can be varied individually.

In many tests in biomedical diagnostics, the problem arises that before the actual test procedure the target molecules first have to be present in a sufficient amount and therefore often have to be amplified from the sample first. The amplification of DNA molecules is performed by means of the polymerase chain reaction (PCR). For the amplification of RNA, the RNA molecules have to be converted to respective complementary DNA (cDNA) by means of reverse transcription. Said cDNA can then also be multiplied (amplified) by means of PCR. PCR is a standard laboratory method (Sambrook et al. (2001) Molecular Cloning: A laboratory manual, 3rd edition, Cold Spring Harbor, N.Y., Cold Spring Harbor Laboratory Press).

In general, devices and methods for the amplification of nucleic acids and their detection should be designed in such a way that as few interventions by an experimenter as possible are necessary. The advantages of methods allowing amplification of nucleic acids and their detection, and in the course of which the experimenter has to intervene only minimally, are obvious. On the one hand, contaminations are avoided. On the other hand, the reproducibility of such methods is substantially increased, as they are accessible to automation. This is also extremely important considering the admission of diagnostic methods.

At present, there are a multiplicity of methods for the amplification of nucleic acids and their detection, wherein first the target material is amplified by means of PCR amplification and subsequently the identity or the genetic state of the target sequences is determined by means of hybridization against a probe array. In general, amplification of the nucleic acid molecules or the target molecules to be detected is necessary in order to have at one's disposal amounts sufficient for a qualitative and quantitative detection within the scope of the hybridization.

Both the PCR amplification of nucleic acids and their detection by means of hybridization are subject to several elementary problems. In the same way, this applies to methods combining a PCR amplification of nucleic acids and their detection by means of hybridization. One of the problems arising in methods combining PCR and hybridization is based on the double-strandedness of the target molecules. Starting from a double-stranded template molecule, classical PCR amplification reactions usually produce double-stranded DNA molecules. These can only hybridize with the probes of the probe array after preceding denaturation. During the hybridization reaction, the very rapid formation of double strands in the solution competes with the hybridization against the immobilized probes of the probe array. The intensity of the hybridization signals, and therefore the quantitative and qualitative evaluation of the results of the method, are strongly limited by this competition reaction.

In addition, there are problems based on the hybridization reaction per se and on the probes and targets made to hybridize. PCR products used as targets for array hybridization reactions normally have a length of at least about 60 base pairs. This corresponds to the sum of the lengths of the forward and reverse primers used for the PCR reaction as well as to the region, which is amplified by the PCR and which exhibits complementarity to the probe on the array. Single-stranded molecules of this length are seldom present in solution in an unstructured form, i.e. linearly stretched, but have more or less stable secondary structures, such as hairpins or other helical structures. If these secondary structures occur in the target region, which exhibits complementarity to the probe, the formation of said secondary structures prevents an efficient hybridization of the target to the probe. Therefore, the formation of secondary structures can also inhibit an efficient hybridization and impede, if not prevent, a quantitative and qualitative evaluation of the results of the method.

Methods in which a single strand excess already emerges during the PCR reaction are generally known as linear or asymmetrical PCR.

In the classical linear PCR reaction, a double-stranded template is amplified in a PCR reaction, to which only one single primer has been added. Correspondingly, starting from this primer, only one of the two strands is produced, which is then present in a excess (Kaltenboeck et al. (1992) Biotechniques, 12(2), 164-166). However, the linear PCR has the disadvantage that the amounts of target it amplifies are usually not sufficient for an efficient quantitative and qualitative detection within the scope of hybridization of a probe array.

We usually speak of a symmetrical PCR, if both primers are present in the same molar amounts. The amplification rate then follows exponential kinetics of the form 2ⁿ (n=number of PCR cycles). The combination of symmetrical PCR reaction with a primer amount limiting with respect to the template and subsequent addition of one single primer in excess followed by a linear amplification is usually described as two-step linear or asymmetrical PCR. The disadvantage of this method is to be seen in that the primer for performing the linear PCR is added only after performing the symmetrical PCR, which represents an additional intervention in the experimental system.

The methods hitherto known have in common the disadvantage that at least one additional reaction step, which requires an intervention by the experimenter, is necessary for the production of single-stranded DNA. Therefore, these methods are not suitable for the application in closed systems or on flow thermocyclers based on meandering channels (Köhler et al. (1998) Micro Channel Reactors for Fast Thermocycling, Proc. 2^{nd} International Conference on Microreaction Technology, New Orleans, 241-247), wherein an addition or a detachment of components during the reaction is not possible.

Alternative methods allow asymmetrical PCR amplification to be performed in one step. For example, a strand can be produced in excess by addition of the primers in an asymmetrical ratio (i.e. one of the primers is present in a smaller molar amount and is used up during the course of the reaction). However, the disadvantage of this method is that a single strand excess is achieved only after reaching a certain concentration of the PCR product. However, achieving this concentration in turn strongly depends on the initial concentration of the template, so that the critical concentration possibly is not even achieved in samples with a small amount of template. The amplification product would then only be present in double-stranded form and the signal in case of a hybridization-based analysis would be weakened disproportionately due to the lowly concentrated samples.

With the hitherto known methods, a satisfactory sensitivity and specificity in the array-based performance of analyses based on amplification of the target material by means of PCR and subsequent analysis of the amplification product by means of hybridization against probe arrays in a continuous process is not ensured. Furthermore, a parallel real-time quantification of targets by means of PCR amplification and hybridization is not possible.

Up to now it had been assumed that the sole performance of an asymmetrical PCR reaction does not amplify an amount of single-stranded nucleic acid molecules large enough to be detected in subsequent detection reactions such as a hybridization with a corresponding probe. Therefore, a two-step asymmetrical or linear PCR had so far always been performed in the prior art for the amplification of single-stranded nucleic acid molecules, i.e. a classical symmetrical PCR amplification was performed before the asymmetrical or linear PCR amplification, which involved, however, multiple experimental interventions, such as the addition of new primers, in the course of process control.

Contrarily to this, the German Patent Application DE 102 53 966 describes a method for efficient amplification of nucleic acids and their detection in a continuous process characterized in that the nucleic acid to be detected is first amplified by means of a PCR in a single-strand excess, wherein at least one competitor inhibiting the formation of one of the two template strands amplified by means of the PCR is added at the beginning of the reaction, and the amplified nucleic acid is detected by means of hybridization with a complementary probe, in particular on microarrays or chips. It has been found that, by means of a PCR reaction, to which a competitor inhibiting the amplification of one of the two template strands was added at the beginning of the reaction, a sufficient amount of single-stranded nucleic acid molecules is produced in excess in order to detect said molecules in a second step by means of hybridization with a complementary probe. While the exponential amplification of the template strands that takes place is attenuated owing to the competitor, however, it still yields an amount of single strands sufficient to ensure an efficient hybridization. In particular, the loss of amount is more than compensated by the single strand excess in hybridization-based assays. It is therefore shown in DE 102 53 966 that by addition of competitors to the PCR reaction setup at the beginning of the amplification reaction both an efficient amplification of the target sequence and a single-strand excess, which is sufficiently high to allow for an efficient quantitative and qualitative detection of the amplified single strands by means of hybridization with corresponding probes, can simultaneously be obtained.

Multiplication of DNA by means of PCR is relatively fast, allows a high throughput of samples in small setup volumes owing to miniaturized methods, and is efficient in operation due to automation. However, a characterization of nucleic acids by means of mere multiplication is not possible. It is rather necessary to apply analysis methods like nucleic acid sequence identification or electrophoretic separation and isolation methods for the characterization of the PCR products subsequently to the amplification.

Thus, there is a great need for devices, which allow the performance of PCR and analysis reaction, such as a hybridization reaction, within one reaction space.

Up to now, the following devices for amplifying target molecules and detecting hybridization reactions in combined form are known:

In WO 01/02094, a device is described wherein PCR and nucleic acid hybridization at a DNA chip are performed as a one-chamber-reaction in a sample chamber with integrated heating system. The device described therein has the disadvantage that a complicated quadropol system is required for mixing the samples and that the setup of this unit requires adhesive bonding of components. Furthermore, the device is unprofitable as a disposable product due to its high production costs. Finally, the handling of this device requires providing specifically adapted tools for processing, such as filling, washing steps, and the like, as well as for reading out the DNA chip.

In U.S. Pat. No. 5,856,174 and U.S. Pat. No. 6,168,948, amplification and hybridization of DNA within one system are described. Purification, labeling, amplification, and hybridization of the target substance are conducted in individual steps. The systems described therein have the disadvantage that the reactions take place in separate reaction chambers. The sample solution is pumped from reaction chamber to reaction chamber by means of a complex device operated with compressed air in order to conduct the respective process steps. Thus, these systems are cartridges of complex construction, which require specifically adapted tools for both processing and detecting.

With the Genestick® described by Relab AG, chemically synthesized oligonucleotides are immobilized to the upper end of a synthetic stick in a grid. The disadvantage of this device is that a stick of this form and these dimensions cannot be processed in 1.5 ml standard laboratory reaction vessels, offered for example by manufacturers like Eppendorf (Hamburg, Germany) or BIOplastics (Landgraaf, Netherlands), due to which reason a reaction vessel specifically offered for this purpose has to be used for said Genestick®. Furthermore, reading out an analysis reaction performed by means of the Genestick® requires providing a specifically adapted device, as due to the dimensions of the stick reading out in standard confocal scanners, like they are used for reading out substance libraries in object holder format, is not possible. It is a further disadvantage of this device that amplification of the sample material is neither provided nor conductible with the Genestick®. This means that the material to be analyzed has to be present in a purified state and in sufficient amount already before processing. Finally, the number of spots is limited to 1,200.

In E. Ermantraut et al. (Building highly diverse arrayed substance libraries by micro offset printing, Micro Total Analysis Systems '98 Workshop, Oct. 13 to 16, 1998, Banff, Canada), a comb for receiving 8 DNA microarrays is described. This device is constructed for the use in microtiter plates and has an individual reaction space closure for each DNA array. It is a disadvantage of this device that due to the integrated closure cap the use in standard reaction machines, such as a thermocycler, is not possible because the closure cap would prevent the closure of the machine lid when used in a standard thermocycler. Therefore, the device is exclusively restricted to the use in microtiter plates. A further disadvantage of this device is the lack of an integration facility for reading out the processed arrays in standard confocal scanners like they are used for reading out substance libraries in object holder format. Thus, a specifically adapted machine format is required for detection.

With respect to the above-described prior art, it becomes evident that there is a great need for devices that can, on the one hand, be provided in a simple and cost-effective manner and, on the other hand, allow simple performance of tests based on microarrays, which particularly serve the exploration and detection of genetic defects and variations. In general, there is a need for devices, which are distinguished by simple construction, easy handling, prevention of contaminating sources, reproducible conductibility of the tests, and low production costs, for performing tests based on microarrays.

It is therefore the problem underlying the present invention to provide a device allowing the parameter-regulated performance of microarray-based tests.

In particular, it is a problem underlying the present invention to provide a device, which is distinguished by simple construction, easy handling, and low-cost production, for performing methods for detecting target molecules with the aid of substance libraries.

Furthermore, it is a problem underlying the present invention to provide a device allowing the performance of a PCR in the presence of substance libraries. In particular, it is a problem underlying the present invention to provide a device allowing the performance of microarray-based tests and particularly the simultaneous performance of PCR and microarray-based tests within a one-chamber system, i.e. a reaction space, at the lowest possible effort and preventing contaminating sources.

Finally, it is a problem underlying the present invention to provide a device allowing fast detection of hybridization signals and increasing the comparability of different microarray-based tests.

These and further problems underlying the present invention are solved by providing the items specified in the patent claims. Preferred embodiments are defined in the subclaims.

### SUMMARY OF THE INVENTION

Object of the present invention is a holding device for substance libraries, which can in particular be used for detecting target molecules with the aid of substance libraries, with:

(i) a holder (101) for a substance library carrier;

(ii) a substance library carrier (104), which can be fixed to the holder (101);

(iii) a detection area (107) applied to the substance library carrier (104), on which detection area a substance library is immobilized; wherein at least the substance library carrier (104) can be introduced into a laboratory reaction vessel (tube).

The holding device for substance libraries according to the present invention has the considerable advantage that the tools and devices of typical everyday laboratory use, which are therefore normally already available in laboratories, such as table centrifuges and pipettes, can be used for detecting specific interactions between molecular target and probe molecules. Therefore, compatibility with devices of general laboratory use is ensured by a substance library carrier introducible into a conventional laboratory reaction vessel. Consequently, in particular processing, especially PCR and/or microarray-based tests, using a substance library carrier of the holding device of the present invention is rendered conductible in a laboratory reaction vessel (tube).

In particular, it is an advantage of the device according to the present invention that a laboratory reaction vessel of typical shape and size can be used as incubation chamber or hybridization chamber for the detection reaction and, if required, for reactions for amplifying target molecules. It is a further advantage of the device according to the present invention that a separate incubation chamber is not necessary, as the laboratory reaction vessel also serves as hybridization chamber. In addition, the carrier surface with the probe molecules immobilized thereon, i.e., the detection area, is protected against contaminations and other adverse external influences during the detection reaction by means of the lid locking typical for conventional laboratory reaction vessels, for example the safe-lock lid locking in Eppendorf reaction vessels.

In a further aspect of the present invention, a carrier system for detecting interactions between target molecules and substance libraries is provided, which comprises the following modules:

a) a holding device for substance libraries containing:
(i) a holder (101) for a substance library carrier;
(ii) a substance library carrier (104), which can be fixed to the holder (101);
(iii) a detection area (107) applied to the substance library carrier (104), on which detection area a substance library is immobilized; and

b) a detection adapter (207), to which at least the substance library carrier (104) can be applied;

wherein the detection adapter has the external dimensions of an object holder for microscopes.

### BRIEF DESCRIPTION OF THE DRAWINGS

FIG. 1: Depiction of a device according to the present invention comprising a holder (101), two flanges (105) for fixing and aligning of the substance library carrier, the substance library carrier (104) with the area to be detected (detection area 107) as well as with the contact area in the detection adapter (109).

FIG. 2: Depiction of a detection adapter in object holder format (207) with contact area (206) and data matrix (208).

For reading out the substance libraries on the detection area (107), the holders (101) with the substance library carriers (104) are placed into the detection adapter (207) in such a way that the detection area (107) is aligned parallel to the focusing plane (201) of the detection device.

FIG. 3: Substance library carrier (104) with detection area (107), lower side (303), and mounted magnet or magnetic material (302).

The lower side (303) of the substance library carrier is preferably magnetically designed, for example by means of providing it with a magnetic layer.

FIG. 4: Depiction of a detection adapter (401) in object holder format.

The provided recesses (403) serve for receiving substance library carriers (104). The ground areas (402) of said recesses are preferably magnetically designed. A data matrix (208) is mounted to the head of the detection adapter (401).

FIG. 5: Handling module (600) for the substance library carriers (104) with handle (605).

By means of a movable shaft, for example a solid cylinder (602), which is guided into a hollow cylinder (601), the substance library carrier (104) with its magnetic connector (302) can be fixed to, and again detached from, the front (604) of the handling module via the magnetic lower end of the shaft.

FIG. 6: Carrier strip (701) with and without substance library carrier (104).

For reading out the array in transmitted light, an opening (703) is provided in the carrier strip. Preferably, a data matrix (208) is mounted at the head of the carrier strip (701).

FIG. 7: Holder (101) with substance library carrier (104) in a 0.5 ml standard PCR reaction vessel (1000).

FIG. 8: Recording of a hybridization pattern.

The substance library carrier was fixed to a holder (101), processed with the latter, and read out in a detection adapter (207).

FIG. 9: Recording of a hybridization pattern.

The substance library carrier was fixed to a holder (701), processed with the latter, and read out in a detection adapter (207).

FIG. 10: Recording of a hybridization pattern.

Negative control of a PCR without Taq polymerase.

FIG. 11: Recording of a hybridization pattern.

The substance library carrier was equipped with a magnet (302), processed with the latter, and read out in a detection adapter (401) as described.

FIG. 12: Gel electrophoresis of the reaction solutions of the hybridization experiments.

FIG. 13: Photo of two standard polypropylene reaction vessels having 1.5 ml filling volume.

FIG. 14: Results of product formation kinetics according to Example 1.

The amount of PCR product formed is indicated in light cycler units, depending on the number of cycles.

FIG. 15: Comparison of hybridization signals depending on the proportion of competitor (see Example 1).

Detection of hybridization signals was performed under a Zeiss fluorescence microscope (Zeiss, Jena, Germany). Excitation was performed in incident light with a white light source and with a set of filters suitable for Cyanine 3. Signals were recorded with a CCD camera (PCO-Sensicam, Kehlheim, Germany). Exposure time was 2,000 ms.

FIG. 16: Agarose gel, whereon 5 μl samples of reactions having a proportion of competitor of 50% and 87.5%, respectively, were analyzed in parallel (see Example 2).

In each case, the reactions had been stopped after the number of cycles indicated. With 87.5% proportion of competitor, less product is generated.

FIG. 17: Dependency of signal strength on proportion of competitor (see Example 2).

The intensity of hybridization signals was measured by averaging the signal strength (measured shade of gray) over the entire region of the spots. The shade of gray value averaged over the spot-free region (background) was subtracted from this value. The signal intensities calculated this way were standardized (highest value=100%) and plotted against the number of cycles.

FIG. 18: Gel analysis of symmetrical and asymmetrical reactions.

In gel analysis of the symmetrical reactions, only one dominating product is detected for all reactions, wherein amplification took place. This is the double-stranded PCR product. Contrarily to this, three dominating products are detected in all detectable asymmetrical reactions. Two further bands corresponding to different structures of the labeled single strand are obtained beside the double-stranded template. Gel analysis shows that asymmetrical amplification leads to a single strand excess.

FIG. 19: Arrangement of the probes according to Example 4.

Black fields represent the probe C2938T, gray fields represent the probe C2938WT.

FIG. 20: Detection of hybridization signals with and without addition of structure breakers (see Example 4).

Detection of hybridization signals was performed under a Zeiss fluorescence microscope. Excitation was performed in incident light with a white light source and with a set of filters suitable for Cyanine 3. The signals were recorded with a CCD camera (PCO-Sensicam). Exposure time was 5,000 ms.

FIG. 21: Detection of hybridization signals (see Example 5).

Detection of hybridization signals was performed under a Zeiss fluorescence microscope. Excitation was performed in incident light with a white light source and with a set of filters suitable for Cyanine 3. The signals were recorded with a CCD camera (PCO-Sensicam). Exposure time was 10,000 ms.

FIG. 22: Arrangement of the probes on the array according to Example 6.

FIG. 23: Detection of the hybridization according to Example 6.

FIG. 23a shows the fluorescence signals after hybridization of a PCR with the addition of structure breakers. The recording was made in a slide scanner with laser power 70 and photomultiplier 80. FIG. 23b shows the negative control without addition of the respective structure breakers. The scanner settings were laser power 100 and photomultiplier 75.

FIG. 24: Depiction of the standardized measurement results from hybridization of a PCR with addition and with lack of structure breakers (see Example 6).

In addition, the ratio of the hybridization signal with and without structure breaker, respectively, is plotted.

FIG. 25: Scanner recordings of the hybridized and washed chips according to Example 7.

FIG. 25a shows fluorescence signals after hybridization of a PCR and addition of structure breakers; FIG. 25b shows the reaction without addition of the corresponding structure breakers.

FIG. 26: Correlation of the individual probes to the array elements according to Example 8.

Array elements occupied by the match probe are depicted in white, probe elements occupied by the detection probe are depicted in black, and probe elements occupied by the insertion probe are depicted in gray.

FIG. 27: Comparison of hybridization signals of asymmetrical and symmetrical reactions for a reaction stopped after 10 and 30 cycles, respectively (see Example 8).

### LIST OF REFERENCE NUMBERS

101 Holder for a substance library carrier
104 Substance library carrier
105 Flange for fixing and aligning of the substance library carrier
106 Fixing site, in particular adhesion site
107 Substance libraries/detection area
108 Gap between the flanges for placing and fixing of the substance library carrier
109 Contact area for placing in a detection adapter
201 Focusing plane
206 Contact area in the detection adapter
207 Detection adapter
208 Data matrix/barcode
301 Fixing site, in particular adhesion site
302 Magnet/magnetic material/other material for detachable fixing
303 Lower side of the substance library carrier
401 Detection adapter
402 Contact area for substance library carrier
403 Recesses for receiving substance library carriers
600 Handling module
601 Hollow cylinder
602 Solid cylinder
603 Magnetic lower end
604 Area for throwing off the substance library carrier
605 Operator button
701 Carrier strip for substance library carriers
702 Adhesive joint
703 Hole for transmitted light detection
1000 Standard reaction vessel (cross-sectional view)

### DETAILED DESCRIPTION

In its standard design, an object holder or standard object holder or slide, also referred to as microscope object holder in the following, for example by manufacturers like Quantifoil (Jena, Germany) or Eppendorf (Hamburg, Germany), has external dimensions of about 76 mm in length, about 25 mm in width, and about 1 mm in height. However, in special embodiments, object holders can also have the following external dimensions: a length in the range of 30 mm to 150 mm, preferably of 50 mm to 100 mm, particularly preferably of 60 mm and most preferably in the range of 74 mm to 78 mm; a width of 10 mm to 50 mm, preferably of 15 mm to 40 mm, particularly preferably of 20 mm to 30 mm and most preferably of 23 mm to 27 mm; and a height of 0.2 mm to 2.0 mm, preferably of 0.5 mm to 1.5 mm, particularly preferably of 0.75 mm to 1.25 mm and most preferably of 0.9 mm to 1.1 mm.

The adapter or detection adapter, like a standard object holder, is compatible with conventional detection and read-out devices and in particular with standard fluorescence scanners and serves for receiving the substance library carrier for reading out the detection area. The fact that the external dimensions of the adapter correspond to those of a standard object holder for microscopes allows the use of any standard detection device, such as a standard fluorescence microscope or a standard confocal scanner. The use of the carrier system according to the present invention in detecting specific interactions between molecular target and probe molecules or substance libraries has the substantial advantage that the acquisition of additional and specifically adapted devices or of additional equipment for the detection is not required.

Therefore, within the scope of the present invention, adapters can be used, which, by virtue of their external dimensions, ensure receiving a holder for a substance library carrier or of a substance library carrier and which can be read out by means of the substance library carrier applied to the adapter or the holder with the substance library carrier, like a standard object holder, applied to the adapter, in a standard confocal scanner or standard fluorescence scanner, such as Scanarray 4000 (GSI Lumonics/Packard), Gen Tac LS (Perkin Elmer) or in standard fluorescence scanners by Genefix (Union City, Calif., USA), Genescan Europe (Freiburg, Germany) and Affymetrix (Santa Clara, Calif., USA).

The holding devices and carrier systems according to the present invention are distinguished by simple construction and cost-effective production and allow easy handling due to the use of devices and instruments usually available in laboratories.

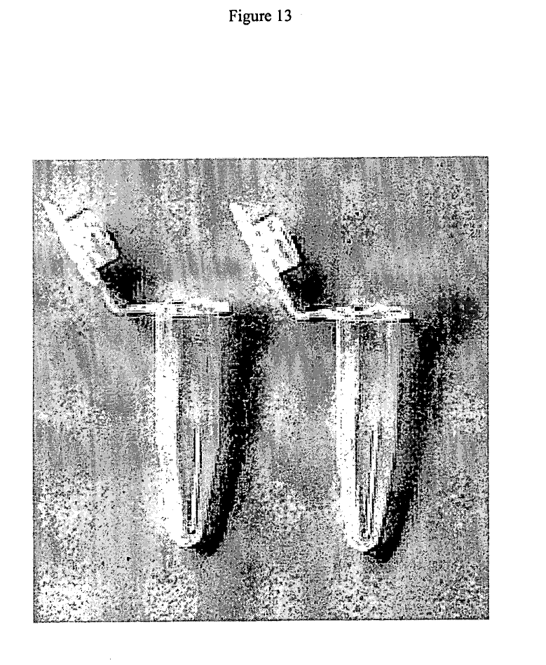

Within the scope of the present invention, laboratory reaction vessels (tubes) are understood to be laboratory reaction vessels of typical shape and size. Laboratory reaction vessels of typical shape and size are reaction vessels normally used in laboratories, particularly biological or molecular biological laboratories, in the form of disposable reaction vessels containing 1.5 ml in standard design or 0.5 ml for performing PCR reactions. Such laboratory reaction vessels are also referred to as tubes and, named after the leading German manufacturer, particularly as Eppendorf tubes or “Eppis” (Hamburg, Germany). Thus, Eppendorf offers laboratory reaction vessels of typical shape and size as standard reaction vessels or safe-lock reaction vessels. Of course, within the scope of the present invention, reaction vessels by manufacturers like Greiner (Frickenhausen, Germany), Millipore (Eschborn, Germany), Heraeus (Hanau, Germany), and BIOplastics (Landgraaf, Netherlands) as well as by other manufacturers can also be used, provided they have a shape and size typical for laboratory reaction vessels, especially by Eppendorf. Examples for laboratory reaction vessels of typical shape and size are shown in FIG. 13.

Filling volumes for laboratory reaction vessels of typical size lie in a range of 100 μl to 2.5 ml, but they can also be higher or lower in special embodiments. Particularly preferably, the laboratory reaction vessel has a filling volume of up to 0.5 ml, which is common for a standard PCR tube. Further typical filling volumes are up to 0.3 ml, up to 0.4 ml, up to 0.7 ml, up to 1.0 ml, up to 1.5 ml or up to 2.0 ml.

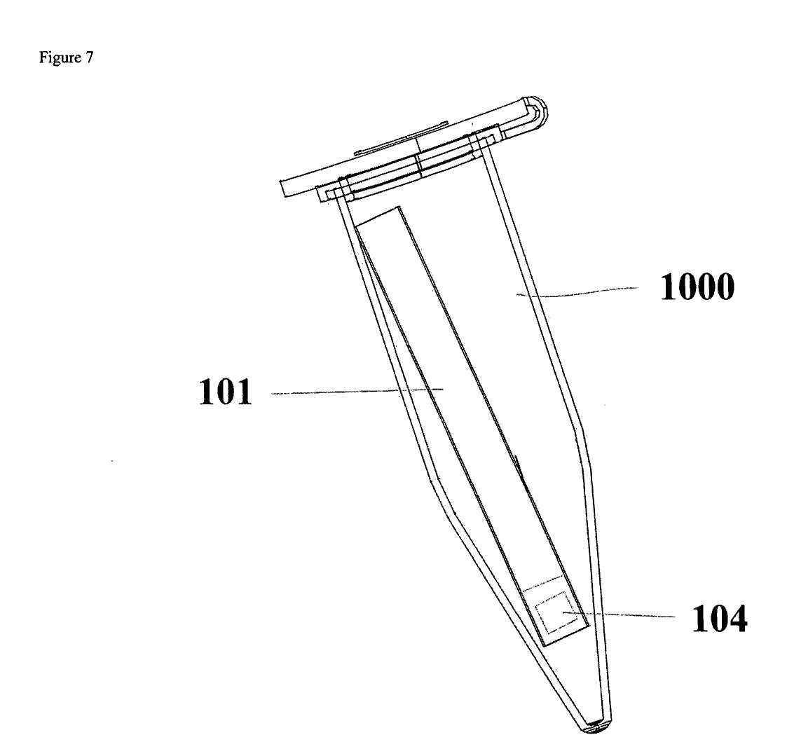

Laboratory reaction vessels of typical shape exhibit a rotationally symmetrical shape, in particular a cylindrical or substantially cylindrical shape. Of the shapes typical for conventional laboratory reaction vessels, a conical shape deviant from the cylindrical basic shape is furthermore also comprised. Further typical shapes are combinations of cylindrical or substantially cylindrical regions and conical regions (see inter alia FIGS. 7 and 13).

In particular, laboratory reaction vessels of typical shape and size are compatible with conventional table centrifuges, such as by manufacturers like Eppendorf and Heraeus. Conventional maximum external diameters for standard laboratory reaction vessels lie in a range of 0.5 cm to 2 cm, preferably of 1.0 cm to 1.5 cm, and particularly preferably of 1.1 cm to 1.3 cm. Further preferred external diameters are up to 0.9 cm, up to 1.2 cm, up to 1.4 cm, up to 1.6 cm and up to 1.7 cm. The height of the laboratory reaction vessel normally is 1.0 cm to 5.0 cm, preferably 2.0 cm to 4.0 cm, particularly preferably 2.5 cm to 3.5 cm, and most preferably 2.8 cm to 3.2 cm. Further preferred heights are up to 2.6 cm, up to 2.7 cm, up to 2.9 cm, up to 3.0 cm, up to 3.1 cm, up to 3.3 cm, and up to 3.4 cm. In special embodiments, the height can also be 0.8 cm or more. The laboratory reaction vessel can, for example, be used in conventional table centrifuges, like a standard table centrifuge with standard rotor by Eppendorf, as well as in conventional racks and holders for reaction vessels, such as a tube rack by Eppendorf. For introducing the sample to be examined and other reagents required for performing the detection reaction into the laboratory reaction vessel, conventional pipettes or syringes, such as variable and fixed volume pipettes by Eppendorf, can be used.

Within the scope of the present invention, laboratory reaction vessels of typical shape and size do in particular not include round-bottomed flasks or other flasks like Erlenmeyer flasks, beaker glasses, or graduated cylinders.

Within the scope of the present invention, an object holder or microscope object holder or standard object holder or slide is understood to denote a glass plate, to which the object to be examined is applied in microscopic examinations. The external dimensions of a standard object holder usually are about 76 mm in length, about 25 mm in width, and about 1 mm in thickness. An overview of such standard substance library carriers in object holder format can be found in M. Schena, Microarray Biochip Technology, Technology Standards for Microarray Research, Eaton Publishing BioTechniques Books Division, Natrick, Ma, USA, 2000).

Furthermore, for the description of the present invention, the following definitions are used inter alia:

Within the scope of the present invention, a probe or a probe molecule is understood to denote a molecule used for detecting other molecules by means of a specific, characteristic binding behavior or a specific reactivity. Any kind of molecules, which can be coupled to solid surfaces and have a specific affinity, can be used as probes arranged on the array. In a preferred embodiment, these are biopolymers from the classes of peptides, proteins, nucleic acids, and/or analogs thereof. Particularly preferably, the probes are nucleic acids and/or nucleic acid analogs.

In particular, nucleic acid molecules of defined and known sequence, which are used for detecting target molecules in hybridization methods, are referred to as probe. Both DNA and RNA molecules can be used as nucleic acids. The oligonucleotide probes can, for example, be oligonucleotides having a length of 10 to 100 bases, preferably of 15 to 50 bases and particularly preferably of 20 to 30 bases. According to the present invention, probes are typically single-stranded nucleic acid molecules or molecules of nucleic acid analogs, preferably single-stranded DNA molecules or RNA molecules, which have at least one sequence region, which is complementary to a sequence region of the target molecules. Depending on the detection method and application, the probes can be immobilized on a solid carrier substrate, for example in the form of a microarray. Moreover, depending on the detection method, they can be labeled radioactively or non-radioactively, so that they can be detected by means of detection reactions common in the prior art.

Within the scope of the present invention, a target or target molecule is understood to denote the molecule to be detected by means of a molecular probe. In a preferred embodiment of the present invention, the targets to be detected are nucleic acids. However, the probe array according to the present invention can be used analogously for detecting protein/probe interactions, antibody/probe interactions, and so on.

If, within the scope of the present invention, the targets are nucleic acid molecules, which are detected by means of hybridization against probes arranged on a probe array, these target molecules usually comprise sequences of 40 to 10,000 bases in length, preferably of 60 to 2,000 bases in length, also preferably of 60 to 1,000 bases in length, particularly preferably of 60 to 500 bases in length and most preferably of 60 to 150 bases in length. If necessary, their sequence comprises the sequence of the primers as well as the sequence regions of the template, which are defined by the primers. In particular, the target molecules can be single-stranded or double-stranded nucleic acid molecules, one or both strands whereof are labeled radioactively or non-radioactively, so that they can be detected by means of a detection method common in the prior art.

According to the present invention, a target sequence is the sequence region of the target, which is detected by means of hybridization with the probe. According to the present invention, this is also referred to as this region being addressed by the probe.

Within the scope of the present invention, a substance library is understood to denote a multiplicity of different molecules, preferably at least 100 different molecules, particularly preferably at least 1,000 different molecules, and most preferably at least 10,000 different molecules. In special embodiments, a substance library can also comprise only at least 50 or less or at least 30,000 different molecules.

Within the scope of the present invention, a probe array is understood to denote an arrangement of molecular probes or of a substance library on a carrier, wherein the position of each probe is defined separately. Preferably, the array comprises defined sites or predetermined regions, the so-called array elements, which are particularly preferably arranged in a particular pattern, wherein each array element usually comprises only one species of probes. Herein, the arrangement of molecules or of probes on the carrier can be generated by means of covalent or non-covalent interactions. A position within the arrangement, i.e. within the array, is usually referred to as spot. The probe array therefore forms the detection area.

Within the scope of the present invention, an array element, or a predetermined region, or a spot is understood to denote a particular area, which is determined for the deposition of a molecular probe, on a surface; the entirety of all occupied array elements is the probe array.

Within the scope of the present invention, a carrier element, or carrier, or substance library carrier is understood to denote a solid body, whereon the probe array is set up. The carrier, usually also referred to as substrate or matrix, can for example be an object holder or a wafer. The entirety of molecules disposed in an array arrangement and carrier is also often referred to as “chip”, “microarray”, “DNA chip”, “probe array” etc.

Conventional microarrays within the scope of the present invention comprise about 50 to about 80,000, preferably about 100 to about 65,000, particularly preferably about 1,000 to about 10,000 different species of probe molecules on an area of several mm² to several cm², preferably about 1 mm² to 10 cm², particularly preferably 2 mm² to 1 cm² and most preferably about 4 mm² to 6.25 cm². For example, a conventional microarray has 100 to 65,000 different species of probe molecules on an area of 2 mm×2 mm.

Within the scope of the present invention, a microtiter plate is understood to denote an arrangement of reaction vessels in a particular pattern, which allows the automated performance of a multiplicity of biological, chemical, and medical laboratory tests.

Within the scope of the present invention, an adapter or detection adapter is understood to denote a module or component, to which the object to be examined, i.e. at least the substance library carrier with the substance library immobilized thereon and optionally the holder with the substance library carrier fixed thereto, is applied in order to allow its examination by means of a detection device. A detection adapter in the sense of the present invention therefore has a function corresponding to that of the object holder in microscopic examinations. In particular, the adapter is a receiving device designed for reading out a microarray.

Within the scope of the present invention, a label is understood to denote a detectable unit, for example a fluorophor or an anchor group, to which a detectable unit can be coupled.

Usually, a primer denotes a short DNA or RNA oligonucleotide (about 12 to 30 bases), which is complementary to a portion of a larger DNA or RNA molecule and has a free 3-OH group at its 3′-end. Due to said free 3′-OH group, the primer can serve as substrate for any DNA or RNA polymerases, which synthesize nucleotides to the primer in 5′-3′ direction. Herein, the sequence of the newly synthesized nucleotides is predetermined by that sequence of the template hybridized with the primer, which is located beyond the free 3′-OH group of the primer. Primers of conventional length comprise between 12 and 50 nucleotides, preferably between 15 and 30 nucleotides. A double-stranded nucleic acid molecule or a nucleic acid strand serving as template for the synthesis of complementary nucleic acid strands is usually referred to as template or template strand.

The formation of double-stranded nucleic acid molecules or duplex molecules from complementary single-stranded nucleic acid molecules is referred to as hybridization. Within the scope of a hybridization, for example DNA-DNA duplexes, DNA-RNA duplexes, or RNA-RNA duplexes can be formed. By means of hybridization, duplexes with nucleic acid analogs can also be formed, such as DNA-PNA duplexes, RNA-PNA duplexes, DNA-LNA duplexes, and RNA-LNA duplexes. Hybridization experiments are normally used for detecting sequence complementarity and therefore identity of two different nucleic acid molecules.

Within the scope of the present invention, processing is understood to denote in particular purification, labeling, amplification, hybridization, and/or washing and rinsing steps as well as further procedure steps performed when detecting targets with the aid of substance libraries.

Therefore, one object of the invention is a holding device comprising

(i) a holder for a substance library carrier;

(ii) a substance library carrier, which can be fixed to said holder; and

(iii) a detection area applied to the substance library carrier, on which detection area a substance library is immobilized;

wherein at least the substance library carrier can be introduced into a laboratory reaction vessel or tube.

In a preferred embodiment of the invention, the entire device according to the present invention, i.e., the usually stick-shaped holder with the substance library carrier fixed thereto, can be introduced into the laboratory reaction vessel. Therefore, the substance library carrier can be introduced into conventional laboratory reaction vessels, such as an Eppendorf tube, either with or without being fixed to a holder. Various procedure steps, such as amplification of target molecules, performance of hybridization reactions, washing and rinsing steps, and further procedure steps usually performed when detecting target molecules with the aid of substance libraries, can be performed in a simple manner in these laboratory reaction vessels. In particular, PCR and microarray-based tests can be performed in one laboratory reaction vessel, in particular simultaneously, with the aid of the holding device according to the present invention.

Preferably, the substance library carrier is fixed to the holder detachably and/or reversibly. Thereby it is ensured that the substance library carrier can, optionally also without the holder, be introduced into a laboratory reaction vessel and can be read out, also without the holder, via an adapter, which will be described in detail in the following, after the detection reaction.

In a further preferred embodiment, the substance library carrier is fixed on the holder. In this embodiment, the holder preferably is a carrier strip, to which the substance library carrier is fixed, for example by means of an adhesive joint. Preferred materials for such carrier strips are synthetics like polypropylene, polyethylene, polycarbonate, and/or paper. Such a device comprising a carrier strip, such as a synthetic strip, to which a substance library carrier is fixed by means of a simple adhesive joint, is a cost-effective tool for analyzing sample material on a genetic basis.

The holder (101) further comprises, in particular at its side turned towards the detection device when reading out the microarray, preferably non-fluorescent or only slightly fluorescent material, such as glass, topaz, Zeonex (Zeon Chemicals L.P., Loisville, Ky., USA), and/or silicon.

Preferably, the holder, in particular the carrier strip, is provided with an opening in vertical projection of the detection area to the holder. This ensures that the area to be detected can be read out both in transmitted light methods, for example by means of a Zeiss Axioscope fluorescence microscope (Zeiss, Jena, Germany), and in incident light methods, for example by means of a Scanarray 4000 device (GSI Lumonics/Packard) or a Gen Tac LS device (Perkin Elmer).

In a further preferred embodiment, the holder has an opening, in which the substance library carrier engages. Preferably, the engagement occurs in a form-fitting manner. Particularly preferably, the holder has two flanges gripping the substance library carrier at its upper and lower side.

In one embodiment of the present invention, the substance library carrier is fixed to the holder by means of adhesion, for example at its front side. Examples for suitable adhesives are one-component silicone, such as Elastosil E43 (Wacker-Chemie GmbH, Munich, Germany), two-component silicone, such as Sylgard 182 and 184 (Dow Corning Corporation, Wiesbaden, Germany); polyurethane resin, such as Wepuran VT 3402 KK (Lackwerke Peters GmbH & Co. KG, Kempen, Germany); epoxide resins, such as SK 201 (SurA Chemicals GmbH, Jena, Germany); and/or acrylates, such as Scotch-Weld DP 8005 (3M Deutschland GmbH, Hilden, Germany).

Preferably, the substance library carrier is fixed to the holder by means of wedging it into the opening. This adhesive-free way of fixing the substance library carrier is usually achieved by means of heating the holder material. Due to heating of the material, the opening, for example between the flanges, will become wider owing to the linear expansion coefficient of the material. The substance library carrier is then placed between the flanges. The substance library carrier is fixed by cooling of the holder and shrinking of the material resulting therefrom. Therefore, in a further preferred embodiment, the holder and particularly the flanges contain material having a high linear expansion coefficient, in particular in a temperature range of 20° C. to 100° C., particularly preferably in a temperature range of 25° C. to 80° C., particularly preferably having a linear expansion coefficient in the range of 0.1·10⁻⁴ K⁻¹ to 1.5·10⁻⁴ K⁻¹ and most preferably of 0.5·10⁻⁴ K⁻¹ to 1.0·10⁻⁴ K⁻¹. In special embodiments, materials having a linear expansion coefficient of 0.05·10⁻⁴ K⁻¹ or higher, or of 2.0·10⁻⁴ K⁻¹ or higher can also be used. Examples for particularly suitable materials having a high linear expansion coefficient are phenylmethylmethacrylate having a linear expansion coefficient of 0.85·10⁻⁴ K⁻¹ in a range of 25° C. to 80° C. and/or polycarbonate having a linear expansion coefficient of 0.7·10⁻⁴ K⁻¹ in a range of 25° C. to 80° C.

In a further preferred embodiment, the substance library carrier (104) is magnetically fixed to the holder. To this end, the areas forming contact areas between holder and substance library carrier are magnetically designed. Such an embodiment allows, in particular, a reversible fixing of the substance library carrier to the holder of the holding device according to the present invention.

Embodiments, wherein the substance library carrier is fixed to the holder without using adhesives, as is described above, have the advantage that a limitation or even a complete inhibition of biochemical reactions of the sample material by adhesives is thereby avoided.

In a further preferred embodiment, the holder comprises a hollow body, in which a shaft is guided. Preferably, the hollow body is a tube, particularly preferably a circular tube. Preferably, the shaft is a solid cylinder. It is further preferred that the shaft has a handle at its upper end.

It is further preferred that the lower end of the shaft as well as one side of the substance library carrier are magnetically designed, so that fixing the substance library carrier to the shaft can be performed via magnetic linkup. Particularly preferably, the device is designed in such a way that by pulling the shaft by its upper end out of the hollow body the substance library carrier connected magnetically to the shaft will be held back by the front face of the hollow body and in this way detached from the holder.

In an alternative embodiment, the front of the hollow body as well as one side of the substance library carrier are magnetically designed. In this embodiment, it is particularly preferred that the device is designed in such a way that by pushing the shaft (602) by its upper end into the hollow body (601) the substance library carrier (104) connected magnetically to the front surface (604) of the hollow body (601) is detached from the holder (600).

By means of the above-described devices comprising a holder or handling module having a hollow cylinder and a shaft, for example a solid cylinder, the substance library carrier can easily be transferred, for example, between different reaction vessels, for example after a PCR and the subsequent rinsing regime, wherein the substance library carrier is tranferred between standard laboratory reaction vessels filled with different solutions and rinsing buffers or into detection devices. For detaching the magnetic linkup, the shaft is, for example by means of pulling at the handle or operator button, pulled upward inside the hollow body or it is pushed into the hollow body. In this manner, the substance library carrier is detached from the handling module each time.

In a further preferred embodiment, the area located opposite the detection area, which will also be referred to as lower side of the substance library carrier in the following, contains material having magnetic properties. This allows for magnetic fixing of the substance library carrier after processing with detection adapters provided therefore, which are also magnetically designed and will be described in detail in the following.

The lower side can be magnetically designed, covering the entire area of the substance library carrier. Preferably, the lower side is magnetically designed only at the edges of the substance library carrier, in particular not in those regions of the area, which are located within the vertical projection of the detection area to the lower side. Thereby, read-out of the substance library or the detection reaction in a transmitted light methods or incident light methods is rendered possible.

Like the holder, the substance library carrier, in particular at its side facing the detection device during read-out of the microarray, preferably contains non-fluorescent or only slightly fluorescent material, such as glass, topaz, Zeonex (Zeon Chemicals L.P., Loisville, Ky., USA) and/or silicon, most preferably glass.

The magnetic design within the scope of the present invention, for example, of the contact areas between holder and substance library carrier, of the shaft at its lower end, or of the hollow body at its front side, or of the substance library carrier at its front or its lower side, is implemented, for example, by means of fixing a magnet or a magnetic material, wherein the fixing is performed in particular by means of adhesion. Alternatively, the area or side to be magnetically designed can be magnetically designed by means of suitable methods, such as sputtering, or by means of a magnetic film, or by means of other methods of thin or thick film technology. An overview of suitable methods for magnetic design of surfaces can, for example, be found in M. Madou; Fundamentals of Microfabrication, CRC Press, Boca Raton, London, New York, Washington D.C., USA, 1997.

In a further preferred embodiment, the holder is individually labeled via a data matrix. To this end, a data set containing information on the substance library, the performance of the detection reaction, and the like is stored in a database when generating the device according to the present invention. It can in particular contain information on the arrangement of probes on the array as well as information on how evaluation is to be performed in the most advantageous manner. The data set or data matrix can further contain information on the temperature/time regime of a PCR to be optionally performed in order to amplify the target molecules. The data set thus established is preferably given a number, which is added to the holder in form of the data matrix. The established data set can then optionally be retrieved via the number recorded in the data matrix when reading out the substance library.

Substance libraries immobilized on microarrays or chips are, in particular, protein libraries, like antibody libraries, receptor protein libraries, or membrane protein libraries, peptide libraries, like receptor ligand libraries, libraries of pharmacologically active peptides or libraries of peptide hormones, and nucleic acid libraries, like DNA or RNA molecule libraries. Particularly preferably, they are nucleic acid libraries.

As already mentioned above, the substance library preferably is immobilized on the substance library carrier or the detection area in form of a microarray, particularly preferably having a density of some 100 up to several 1,000 array spots per cm².

Furthermore, pre-amplification of the material to be analyzed is not required in all of the above-described embodiments of the device according to the present invention. From the sample material extracted from bacteria, blood or other cells, specific parts can be amplified and hybridized to the carrier with the aid of a PCR (polymerase chain reaction), in particular in the presence of the device according to the present invention or the substance library carrier, as described in DE 102 53 966. This represents a substantial reduction of effort.

The holding device according to the present invention is therefore particularly suitable for the use in parallel performance of amplification of the target molecules to be analyzed by means of PCR and detection by means of hybridization of the target molecules with the substance library carrier. The nucleic acid to be detected is first amplified by means of a PCR, wherein at least one competitor is added to the reaction in the beginning, inhibiting the formation of one of the two template strands amplified by means of the PCR. In particular, a DNA molecule, which competes with one of the primers used for the PCR amplification of the template for binding to the template and which can not be extended enzymatically, is added to the PCR. The single-stranded nucleic acid molecules amplified via PCR are then detected by means of hybridization with a complementary probe. Alternatively, the nucleic acid to be detected is first amplified in single strand excess by means of a PCR and is detected by means of a subsequent hybridization with a complementary probe, wherein a competitor, which is a DNA molecule or a molecule of a nucleic acid analog capable of hybridizing to one of the two strands of the template but not to the region detected by means of probe hybridization and which cannot be extended enzymatically, is added to the PCR reaction at the beginning.

Every molecule causing a preferred amplification of only one of the two template strands present in the PCR reaction can be used as competitor in the PCR. According to the present invention, competitors can be proteins, peptides, DNA ligands, intercalators, nucleic acids, or analogs thereof. Proteins or peptides, which are capable of binding single-stranded nucleic acids with sequence specificity and which have the above-defined properties, are preferably used as competitors. Particularly preferably, nucleic acid molecules and nucleic acid analog molecules are used as secondary structure breakers.

The formation of one of the two template strands is substantially inhibited by initial addition of the competitor to the PCR during the amplification. “Substantially inhibited” means that within the scope of the PCR a single strand excess and an amount of the other template strand are produced, which suffice to ensure an efficient detection of the amplified strand by means of the hybridization. Therefore, the amplification does not follow exponential kinetics of the form 2ⁿ (with n=number of cycles), but rather attenuated amplification kinetics of the form <2ⁿ.

The single strand excess obtained by means of the PCR has the factor 1.1 to 1,000, preferably the factor 1.1 to 300, also preferably the factor 1.1 to 100, particularly preferably the factor 1.5 to 100, also particularly preferably the factor 1.5 to 50, in particular preferably the factor 1.5 to 20, and most preferably the factor 1 to 10, in relation to the non-amplified strand.

Typically, it will be the function of a competitor to bind selectively to one of the two template strands and therefore to inhibit amplification of the respective complementary strand. Therefore, competitors can be single-stranded DNA- or RNA-binding proteins having specificity for one of the two template strands to be amplified in a PCR. They can also be aptamers, which bind sequence-specifically only to specific regions of one of the two template strands to be amplified.

Nucleic acids or nucleic acid analogs are preferably used as competitors. Usually, the nucleic acids or nucleic acid analogs will act as competitors of the PCR by either competing with one of the primers used for the PCR for the primer binding site or by being capable of hybridizing with a region of a template strand to be detected due to a sequence complementarity. This region is not the sequence detected by the probe. Such nucleic acid competitors are enzymatically not extendable.

The nucleic acid analogs can, for example, be so-called peptide nucleic acids (PNA). However, nucleic acid analogs can also be nucleic acid molecules, in which the nucleotides are linked to one another via a phosphothioate bond instead of a phosphate bond. They can also be nucleic acid analogs, wherein the naturally occurring sugar components ribose or deoxyribose were replaced by alternative sugars such as arabinose or trehalose. Furthermore, the nucleic acid derivative can be “locked nucleic acid” (LNA). Further conventional nucleic acid analogs are known to the person skilled in the art.

Preferably, DNA or RNA molecules, in particular preferably DNA or RNA oligonucleotides or their analogs, are used as competitors.

Depending on the sequence of the nucleic acid molecules or nucleic acid analogs used as competitors, the inhibition of the amplification of one of the two template strands within the scope of the PCR reaction is based on different mechanisms. By way of the example of a DNA molecule, this is discussed in the following.

If, for example, a DNA molecule is used as competitor, it can have a sequence, which is at least partially identical to the sequence of one of the primers used for the PCR in such a way that a specific hybridization of the DNA competitor molecule with the corresponding template strand is possible under stringent conditions. As, in this case, the DNA molecule used for competition is not extendable by means of a DNA polymerase, the DNA molecule competes with the respective primer during the PCR reaction for binding to the template. According to the ratio of DNA competitor molecule and primer, the amplification of the template strand defined by the primer can thus be inhibited in such a way that the production of this template strand is significantly reduced. The PCR proceeds according to exponential kinetics higher than would be expected with respect to the amounts of competitors used. In this manner, a single strand excess arises in an amount, which is sufficient for an efficient detection of the amplified target molecules by means of hybridization.

In this embodiment, the nucleic acid molecules or nucleic acid analogs used for competition must not be enzymatically extendable. “Enzymatically not extendable” means that the DNA or RNA polymerase used for amplification cannot use the nucleic acid competitor as primer, i.e. it is not capable of synthesizing the corresponding opposite strand of the template 3′ from the sequence defined by the competitor.

Alternatively to the above-depicted possibility, the DNA competitor molecule can also have a sequence complementary to a region of the template strand to be detected, which is not addressed by one of the primer sequences, and which sequence is enzymatically not extendable. Within the scope of the PCR, the DNA competitor molecule will then hybridize to this template strand and accordingly block amplification of this strand.

The person skilled in the art knows that the sequences of DNA competitor molecules or, in general, nucleic acid competitor molecules can be selected correspondingly. If the nucleic acid competitor molecules have a sequence, which is not substantially identical to the sequence of one of the primers used for the PCR, but is complementary to another region of the template strand to be detected, this sequence is to be selected in such a way that it does not fall within the region of the template sequence, which is detected with a probe within the scope of the hybridization. This is necessary because a processing reaction between the PCR and the hybridization reaction does not have to take place. If a nucleic acid molecule, which falls within the region to be detected, was used as competitor, it would compete with the single-stranded target molecule for binding to the probe.

Such competitors preferably hybridize near the template sequence detected by the probe. Herein, the position specification “near” is to be understood in the same way as given for secondary structure breakers. However, the competitors can also hybridize in the immediate proximity of the sequence to be detected, i.e. at exactly one nucleotide's distance from the target sequence to be detected.

If enzymatically not extendable nucleic acids or nucleic acid analogs are used as competing molecules, they are to be selected according to their sequence and structure in such a way that they cannot be enzymatically extended by DNA or RNA polymerases. Preferably, the 3′-end of a nucleic acid competitor is designed in such a way that it has no complementarity to the template and/or has another substituent instead of the 3-OH group at its 3′-end.

If the 3′ end of the nucleic acid competitor has no complementarity to the template, regardless of whether the nucleic acid competitor binds to one of the primer binding sites of the template or to one of the sequences of the template to be amplified by means of the PCR, the nucleic acid competitor cannot be extended by conventional DNA polymerases due to the lack of base complementarity at its 3′-end. This type of non-extensibility of nucleic acid competitors by DNA polymerases is known to the person skilled in the art. Preferably, the nucleic acid competitor has no complementarity to its target sequence at its 3′-end with respect to the last 4 bases, particularly preferably to the last 3 bases, in particular preferably to the last 2 bases, and most preferably to the last base. In the mentioned positions, such competitors can also have non-natural bases, which do not allow hybridization.

Nucleic acid competitors, which are enzymatically not extendable, can also have a 100% complementarity to their target sequence, if their backbone or their 3′-end are modified in such a way that they are enzymatically not extendable.

If the nucleic acid competitor has a group other than the OH group at its 3′-end, these substituents preferably are a phosphate group, a hydrogen atom (dideoxynucleotide), a biotin group, or an amino group. These groups cannot be extended by conventional polymerases.

Particularly preferably, a DNA molecule is used as a competitor in such a method, which competes with one of the two primers used for the PCR for binding to the template, and which was provided with an amino link at its 3′-end during chemical synthesis. Such competitors can have 100% complementarity to their target sequence.

However, nucleic acid analoga competitors such as PNAs do not have to have a blocked 3′ OH group or a non-complementary base at their 3′-end as they are not recognized by the DNA polymerases because of the backbone modified by the peptide bond and thus are not extended. Other analogous modifications of the phosphate group, which are not recognized by the DNA polymerases, are known to the person skilled in the art. Among those are, inter alia, nucleic acids having backbone modifications, such as 2′-5′ amide bonds (Chan et al. (1999) J. Chem. Soc., Perkin Trans. 1, 315-320), sulfide bonds (Kawai et al. (1993) Nucleic Acids Res., 1 (6), 1473-1479), LNA (Sorensen et al. (2002) J. Am. Chem. Soc., 124 (10), 2164-2176) and TNA (Schoning et al. (2000) Science, 290 (5495), 1347-1351).

Several competitors hybridizing to different regions of the template (for example, inter alia, the primer binding site) can also simultaneously be used in a PCR. The efficiency of the hybridization can additionally be increased, if the competitors have properties of secondary structure breakers.

In an alternative embodiment, the DNA competitor molecule can also have a sequence complementary to one of the primers. Depending on the quantity ratio of antisense DNA competitor molecule and primer, such, for example, antisense DNA competitor molecules can then be used to titrate the primer in the PCR reaction, so that it will no longer hybridize with the respective template strand and, accordingly, only the template strand defined by the other primer is amplified. The person skilled in the art is aware of the fact that, in this embodiment of the invention, the nucleic acid competitor can, but does not have to, be enzymatically extendable.

If, within the scope of the present invention, nucleic acid competitors are mentioned, this includes nucleic acid analog competitors, unless a different meaning arises from the context. The nucleic acid competitor can bind to the corresponding strand of the template reversibly or irreversibly. The binding can take place via covalent or non-covalent interactions.

Preferably, binding of the nucleic acid competitor takes place via non-covalent interactions and is reversible. In particular preferably, binding to the template takes place via formation of Watson-Crick base pairings.

The sequences of the nucleic acid competitors normally follow the sequence of the template strand to be detected. In the case of antisense primers, though, they follow the primer sequences to be titrated, which are in turn defined by the template sequences.

PCR amplification of nucleic acids is a standard laboratory method, whose various possibilities of variation and design are familiar to the person skilled in the art. In principle, a PCR is characterized in that the double-stranded nucleic acid template, usually a double-stranded DNA molecule, is first subjected to heat denaturation for 5 minutes at 95° C., whereby the two strands are separated from each other. After cooling down to the so-called “annealing” temperature (defined by the primer with the lower melting temperature), the forward and reverse primers present in the reaction solution bind to those sites in the respective template strands, which are complementary to their own sequences. The “annealing” temperature of the primers depends on the length and base composition of the primers. It can be calculated on the basis of theoretical considerations. Information on the calculation of “annealing” temperatures can be found, for example, in Sambrook et al. (vide supra).

Annealing of the primers, which is typically performed in a temperature range of 40 to 75° C., preferably of 45 to 72° C. and in particular preferably of 50 to 72° C., is followed by an elongation step, wherein deoxyribonucleotides are linked to the 3′-end of the primers via the activity of the DNA polymerase present in the reaction solution. The identity of the inserted dNTPs depends on the sequence of the template strand hybridized with the primer. As normally thermostable DNA polymerases are used, the elongation step usually runs at between 68 and 72° C.

In a symmetrical PCR, an exponential increase of the nucleic acid region of the target defined by the primer sequences is achieved by means of repeating this described cycle of denaturation, annealing of the primers and elongation of the primers. With respect to buffer conditions of the PCR, usable DNA polymerases, production of double-stranded DNA templates, design of primers, selection of the annealing temperature, and variations of the classical PCR, the person skilled in the art has numerous works of literature at his disposal.

It is familiar to the person skilled in the art that also, for example, single-stranded RNA, such as mRNA, can be used as template. Usually, the former is precedingly transcribed into a double-stranded cDNA by means of reverse transcription.

In a preferred embodiment, a thermostable DNA-dependent DNA polymerase is used as polymerase. In a particularly preferred embodiment, a thermostable DNA-dependent DNA polymerase is used, which is selected from the group consisting of Taq DNA polymerase (Eppendorf, Hamburg, Germany and Qiagen, Hilden, Germany), Pfu DNA polymerase (Stratagene, La Jolla, USA), Tth DNA polymerase (Biozym Epicenter Technol., Madison, USA), Vent DNA polymerase, DeepVent DNA polymerase (New England Biolabs, Beverly, USA), Expand DNA polymerase (Roche, Mannheim, Germany).

The use of polymerases, which have been optimized starting from naturally occurring polymerases by means of specific or evolutive alteration, is also preferred. When performing the PCR in the presence of the substance library carrier, the use of the Taq polymerase by Eppendorf (Germany) and of the Advantage cDNA Polymerase Mix by Clontech (Palo Alto, Calif., USA) is in particular preferred.

In a further aspect of the present invention, a carrier system is provided, which can in particular be used for detecting interactions between target molecules and substance libraries, wherein the system has the following modules:

a) a holding device for substance libraries comprising:

(i) a holder for a substance library carrier;

(ii) a substance library carrier, which can be fixed to said holder;

(iii) a detection area applied to the substance library carrier, on which a substance library is immobilized;

b) a detection adapter, to which at least the substance library carrier (104) can be applied;

wherein the adapter has the external dimensions of a microscope object holder.

The external dimensions of the detection adapter of the device according to the present invention are similar to the dimensions of a standard substance library carrier in object holder format. Thus, standard fluorescence microscopes, such as the Zeiss Axioscope fluorescence microscope (Zeiss), or standard confocal scanners, such as Scanarray 4000 (GSI Lumonics/Packard), or Gen Tac LS (Perkin Elmer), which are normally used for reading out substance library carriers in object holder format, can be used.

The holding device a) of the holding system according to the present invention preferably is designed like the above-described holding device for substance libraries according to the present invention.

Preferably, the entire holder with the substance library carrier fixed thereto can be applied to the adapter.

In a further preferred embodiment, the adapter has recesses, which can receive the holder with the substance library carrier or the substance library carrier alone.

In a preferred embodiment, the holder with the substance library carrier and/or the substance library carrier is applied to the adapter in a detachable manner. This can in particular be achieved by magnetically designing the contact area for the holder with the substance library carrier and/or the substance library carrier of the detection adapter, which is adapted for reading out the substance library carrier, and/or the counterpart, i.e. the holder with the substance library carrier and/or the substance library carrier, by means of suitable methods as described above. It is particularly preferred that the basic or contact areas of recesses formed for receiving the holder with the substance library carrier and/or the substance library carrier are magnetically designed.

In turn, the magnetic design of the contact area of the adapter can involve the entire region of the contact area or only the edges of the contact area. Non-magnetic design of regions of the contact area located within the vertical projection of the detection area to the contact area allows detection in transmitted or incident light methods.

In alternative embodiments, the holder with the substance library carrier and/or the substance library carrier are detachably or reversibly applied to the adapter in a different manner. Such an embodiment is therefore based on adhesion between glass and silicone, such as Sylgard 184 (Dow Corning, Mich., USA). To this end, for example, the contact area for the holder with the substance library carrier and/or the substance library carrier of the detection adapter, which is adapted for reading out the substance library carrier, can be equipped with a silicone layer, if a holder or a substance library carrier consisting of glass is used.

Preferably, the detection adapter consists of optically transparent and/or non-fluorescent materials. These materials are, for example, glass, Borofloat 33 (Schott, Zwiesel, Germany), quartz glass, single-crystal CaF₂ (Schott), single-crystal silicon, Zeonex, phenylmethylmethacrylate and/or polycarbonate.

In a further preferred embodiment, the contact area of the adapter for the holder with the substance library carrier and/or the substance library carrier is aligned parallel to the detection area or the focusing plane of the detection device.

This can, for example, be ensured as follows: Flanges at the holder can serve for parallel alignment of the substance library carrier with the holder and its contact area determined for application to the detection adapter. The contact area, which is provided for the holder in the detection adapter, is aligned parallel to the focusing plane of the detection device. Thereby, plane alignment of the detection area in relation to the focusing plane is achieved when applying the holder and/or the substance library carrier to or inserting it into the detection adapter. Tilting of the area to be read out in relation to the focusing plane is avoided by means of parallel alignment of the contact area of the detection adapter with the area to be detected of the substance library carrier.

In a further preferred embodiment, several holders and/or substance library carriers, preferably more than four, particularly preferably at least eight and up to ten or more holders and/or substance library carriers, can be applied to the adapter. Particularly preferably, substance library carriers of different geometric shapes, such as rectangular or round substance library carriers, can be applied to the adapter. Thus, the internal shape of the detection adapter, in particular recesses provided for receiving the holder and/or the substance library carrier, can be adapted to different geometric shapes or formats of substance library carriers.

A detachable, preferably magnetic, fixing of the substance library carrier to the holder allows the application of only the substance library carrier to the adapter. Thus, the space required for the substance library carriers to be read out is minimized and spatial limitations, such as when reading out substance library carriers in confocal scanner devices, are avoided. Thus, several substance library carriers can further simultaneously, i.e. within one working step, be detected by means of application to a detection adapter. The simultaneous reading out of, for example, several differently processed substance library carriers in a detection adapter allows improvement of the comparability of the results obtained.

In a further preferred embodiment, the substance library carrier is fixed, in particular adhesively fixed, to a carrier strip like described above. In order to allow for reading out the area to be detected both by transmitted and invasive light methods, the carrier strip is provided with an opening underneath the detection area. In this embodiment of the device according to the present invention, the carrier strip can be applied to the detection adapter together with the substance library carrier fixed on it. After processing, in particular after performing the detection reaction as well as, optionally, a PCR, as well as several washing steps, the holder or carrier strip with the substance library carrier is dried and subsequently placed onto the contact area of the detection adapter provided to this end. Reading out of the substance library is performed in the same manner as described above. In this embodiment, the external dimensions of the detection adapter are also similar to the dimensions of a standard substance library carrier in object holder format.

According to the present invention, the devices described above are used for performing microarray-based tests, in particular for performing hybridization tests, but also for performing a PCR, an LCR, or an LDR. In particular, the devices according to the present invention can be used for simultaneously performing a microarray-based test and a PCR.

In the following, the invention is explained by way of concrete examples. These are not to be interpreted restrictively.

### EXAMPLES

### Example 1

Comparative hybridization of PCR products generated by means of symmetrical PCR and by means of asymmetrical PCR according to the present invention with graded proportion of competitors against immobilized probes.

Amplification Kinetics of the Asymmetrical PCR:

In an initial experiment, it was first examined to which extent PCR product formation depends on the proportion of competitor. To this end, PCR reactions having identical primer concentrations but different proportion of competitors were first performed.

The competitor was a DNA oligonucleotide having the same sequence as the reverse primer of the PCR, but was modified with an NH₂ group at the 3′-OH group at its 3′-end. The amino modification was integrated into the molecule during chemical synthesis of the oligonucleotide (3′-amino modifier C7, Glen Research Corp., Sterling, Va., USA).

PCR Reactions:

The forward primer 16sfD1Cy3 had the following sequence and was labeled with Cy3 at its 5′-end.

5′-AGAGTTTGATCCTGGCTCAG-3′

The reverse primer had the following sequence:

5′-TACCGTCACCATAAGGCTTCGTCCCTA-3′

PCR setups having different proportion of competitors were prepared. Each PCR setup had the following composition and final concentrations.

1×PCR reaction buffer (Eppendorf Hamburg, Germany)

200 μM forward-Primer 16sfD1Cy3, labeled with the fluorescent dye Cy3 (Amersham-Pharmacia, Freiburg, Germany) at its 5′-end

200 μM dNTPs

0.05 U/μl Taq polymerase (Eppendorf Hamburg, Germany)

2 ng/μl chromosomal DNA Corynebacterium glutamicum additional contents were:

Reaction 1: 200 nM reverse primer 16s Ra (corresponding to 0% competitor, symmetrical PCR)

Reaction 2: 0 nM reverse primer 16s Ra

200 nM competitor 16s Ra 3′ NH2 (corresponding to 100% competitor, asymmetrical PCR)

Reaction 3: 10 nM reverse primer 16s Ra

190 nM competitor 16s Ra 3′ NH2 (corresponding to 95% competitor, asymmetrical PCR)

Reaction 4: 20 nM reverse primer 16s Ra

180 nM competitor 16s Ra 3′ NH2 (corresponding to 90% competitor, asymmetrical PCR)

Reaction 5: 40 nM reverse primer 16s Ra

160 nM competitor 16s Ra 3′ NH2 (corresponding to 80% competitor, asymmetrical PCR)

Reaction 6: 60 nM reverse primer 16s Ra

140 nM competitor 16s Ra 3′ NH2 (corresponding to 70% competitor, asymmetrical PCR)

Reaction 7: 100 nM reverse primer 16s Ra

100 nM competitor 16s Ra 3′ NH2 (corresponding to 50% competitor, asymmetrical PCR)

Reaction 8: 140 nM reverse primer 16s Ra

60 nM competitor 16s Ra 3′ NH2 (corresponding to 30% competitor, asymmetrical PCR)

The total volume of each PCR setup was 25 μl. The reactions were performed according to the following temperature regime:

| | | | |
|---|---|---|---|
| Initial denaturation: | 2 | min | 95° C. |
| 25 cycles: | 30 | sec | 95° C. |
| | 30 | sec | 60° C. |
| | 30 | sec | 72° C. |
| Terminal elongation: | 7 | min | 72° C. |

The reaction setups were filled into LightCycler cuvettes (Roche Diagnostics, Mannheim, Germany) and the PCR reaction was performed in the LightCycler (Roche Diagnostics, Mannheim, Germany). Product formation kinetics were recorded according to the manufacturer's instructions.

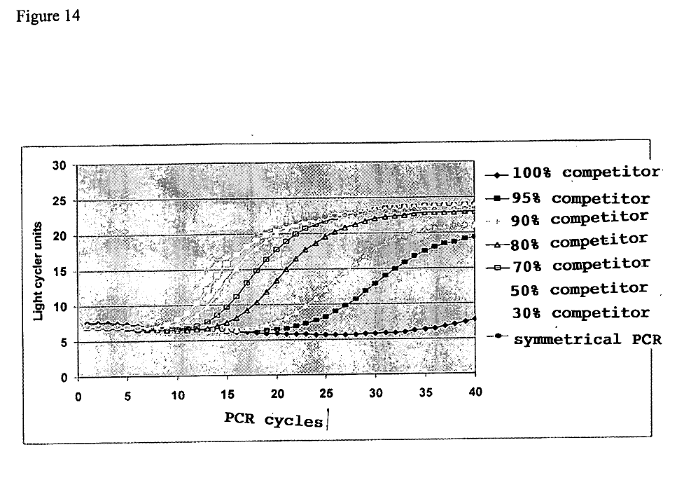

The results are depicted in FIG. 14 (FIG. 14). Herein, the amount of PCR product formed is given as LightCycler units depending on the number of cycles.

It can clearly be seen that the efficiency of the PCR and accordingly the product yield decreases as the proportion of competitor increases.

Comparison of Hybridization Signals Depending on the Proportion of Competitor:

In the following, product formation and hybridization signal were compared in the cases of symmetrical and asymmetrical PCR amplification with different proportion of competitors at a certain time point (completion of the reaction after 25 cycles).

The same primers and competitors were used as specified above.

PCR Reactions:

PCR setups with different proportion of competitors were prepared. Each PCR setup had the following composition and final concentrations.

1×PCR reaction buffer (Eppendorf Hamburg, Germany)

200 nM forward primer 16sfD1Cy3, labeled with the fluorescent dye Cy3 at its 5′-end (Amersham-Pharmacia, Freiburg, Germany) 16sfD1Cy3

200 μM dNTPs

0.05 U/μl Taq polymerase (Eppendorf Hamburg, Germany)

2 ng/μl chromosomal DNA Corynebacterium glutamicum additional contents were:

Reaction 1: 200 nM reverse primer 16s Ra (corresponding to 0% competitor, symmetrical PCR)

Reaction 2: 80 nM reverse primer 16s Ra

120 nM competitor 16s Ra 3′ NH2 (corresponding to 60% competitor, asymmetrical PCR)

Reaction 3: 40 nM reverse primer 16s Ra

160 nM competitor 16s Ra 3′ NH2 (corresponding to 80% competitor, asymmetrical PCR)

Reaction 4: 20 nM reverse primer 16s Ra

180 nM competitor 16s Ra 3′ NH2 (corresponding to 90% competitor, asymmetrical PCR)

The reactions were performed according to the same temperature protocol as above:

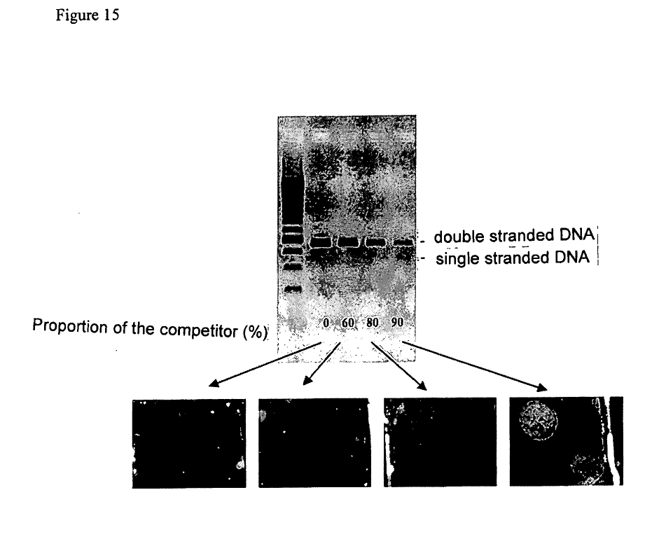

The total volume of each PCR was 25 μl. 5 μl of each of the PCR setups were analyzed on a 2% agarose gel (FIG. 15). It can be seen that the amount of double-stranded DNA decreases and the amount of single-stranded DNA increases as the proportion of competitor increases.

Subsequently, the remaining 20 μl of the PCR reactions were purified by means of the Qiaquick PCR purification kit (Qiagen, Hilden, Germany) according to the manufacturer's instructions. The elution of the PCR fragments was performed in 50 μl water in each case. The eluate was vacuum concentrated to 10 μl.

Immobilization of the Hybridization Probes:

On glass surfaces of the size of 3×3 mm (chip), which were coated with an epoxide, an amino-modified oligonucleotide with a length of 18 nucleotides of the sequence 5′-NH₂— GTTTCCCAGGCTTATCCC-3′) was covalently immobilized at two defined sites (spot).

To this end, 0.1 μl of a 5 μM solution of the oligonucleotide in 0.5 M phosphate buffer were applied on the glass surface and then dried at 37° C. The covalent linking of the applied oligonucleotides with the epoxide groups on the glass surface was performed by 30 min baking of the chips at 60° C. Subsequently, the chips were vigorously rinsed with distilled water and then washed for 30 min in 100 mM KCl. After further short rinsing in 100 mM KCl and subsequently in distilled water, the chips were dried for 10 min at 37° C.

Hybridization:

2 μl of the purified PCR aliquots were taken up in 50 μl 6×SSPE, 0.1% SDS (Sambrook et al., vide supra). A chip was added to each hybridization solution. The reaction was denatured for 5 min at 95° C. and subsequently incubated for 1 h at 50° C. Subsequently, 3 successive 5 min washing steps at 30° C. in 2×SSC, 0.1% SDS, at 30° C. in 2×SSC, and at 20° C. in 0.2×SSC were performed (Sambrook et al. vide supra). The chips were subsequently vacuum dried.

Detection of the Hybridization Signals:

The detection of hybridization signals was performed under a Zeiss fluorescence microscope (Zeiss, Jena, Germany). Excitation was performed in incident light with a white light source and with a set of filters suitable for Cyanine 3. The signals were recorded with a CCD camera (PCO-Sensicam, Kehlheim, Germany). Exposure time was 2000 ms. (FIG. 15)

Results:

It turned out that the PCR products generated according to the method of the present invention exhibited significantly increased hybridization signals despite a significantly decreased amount of product.

As the competitor concentration increases in a range of 0-90% proportion of competitor, an increase of the hybridization signal can be observed, although the total amount of product decreases. Surprisingly, the best signals were achieved with the highest proportion of competitor (90%) and therefore with the smallest amount of single-stranded DNA.

### Example 2

A quantitative analysis of the hybridization signal depending on the proportion of competitor was performed. The same forward and reverse primers and the same competitor as in Example 1 were used for the PCR.

PCR setups having the following composition and final concentrations were prepared:

all reactions contained:

1×PCR reaction buffer (Eppendorf Hamburg, Germany)

200 nM forward primer 16sfD1Cy3, labeled with the fluorescent dye Cy3 (Amersham-Pharmacia, Freiburg, Germany) at its 5′-end

200 μM dNTPs

0.05 U/μl Taq polymerase (Eppendorf Hamburg, Germany)

2 ng/μl chromosomal DNA Corynebacterium glutamicum

additional contents were:

Reaction 1: 266 nM reverse primer 16s Ra, no competitor (symmetrical PCR)

Reaction 2: 133 nM reverse primer 16s Ra

133 nM competitor 16s Ra 3′ NH2 (corresponding to 50% competitor, asymmetrical PCR)

Reaction 3: 40 nM reverse primer 16s Ra

160 nM competitor 16s Ra 3′ NH2 (corresponding to 75% competitor, asymmetrical PCR)

Reaction 4: 33 nM reverse primer 16s Ra

233 nM competitor 16s Ra 3′ NH2 (corresponding to 87.5% competitor, asymmetrical PCR)

The reactions were divided into aliquots of 25 μl each. The temperature protocol was identical to Example 1. One aliquot of each of the reactions 1 to 4 was taken after 15, 20, 25, 30, and 35 PCR cycles, respectively.

5 μl of each aliquot were analyzed on a 2% agarose gel in each case. Gel analysis showed that significantly more PCR product was produced with a small number of cycles in a symmetrical PCR than in the asymmetrical PCR reaction.

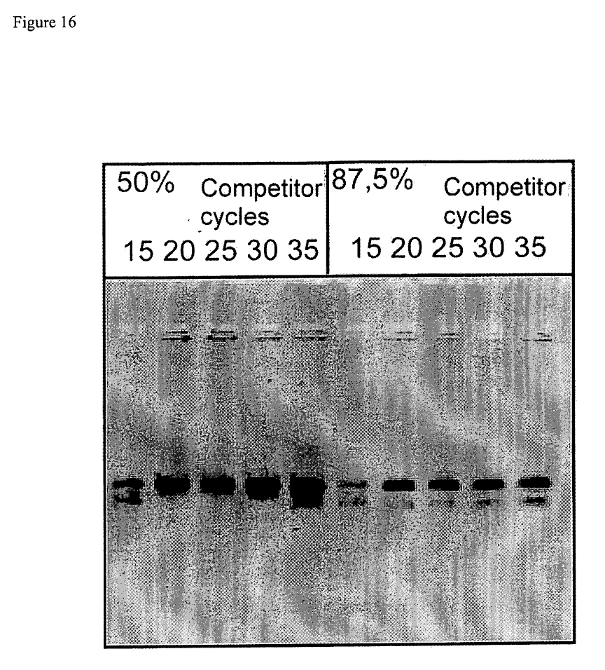

FIG. 16 (FIG. 16) shows an agarose gel, whereon 5 μl samples of reactions having a proportion of competitor of 50% and 87.5% were analyzed in parallel. The reactions had each been stopped after the indicated number of cycles. It can be seen that less product is produced with 87.5% proportion of competitor.

Immobilization of the Hybridization Probes:

On glass surfaces of the size of 3×3 mm (chip), which were coated with an epoxide, an amino-modified oligonucleotide with a length of 18 nucleotides of the sequence 5′-NH₂— GTTTCCCAGGCTTATCCC-3′) was covalently immobilized at two defined sites (spot).

To this end, 0.1 μl of a 5 μM solution of the oligonucleotide in 0.5 M phosphate buffer were applied on the glass surface and dried at 37° C. Covalent linking of the applied oligonucleotides with the epoxide groups on the glass surface was performed by 30 min baking of the chips at 60° C. Subsequently, the chips were vigorously rinsed with distilled water and then washed for 30 min in 100 mM KCl. After further short rinsing in 100 mM KCl and subsequently in distilled water, the chips were dried for 10 min at 37° C.

Hybridization:

Additional 5 μl of the reaction were mixed with 50 μl 6×SSPE, 0.1% SDS and used in hybridization experiments (Sambrook et al., vide supra). A chip was added to each hybridization solution. The reaction was denatured for 5 min at 95° C. and subsequently incubated for 1 h at 50° C. Subsequently, three successive 5 min washing steps at 30° C. in 2×SSC, 0.1% SDS, at 30° C. in 2×SSC, and at 20° C. in 0.2×SSC were performed. The chips were subsequently vacuum dried.

Detection of Hybridization Signals:

The detection of hybridization signals was performed under a Zeiss fluorescence microscope (Zeiss, Jena, Germany). Excitation was performed in incident light by means of a white light source and with a set of filters suitable for Cyanine 3. The signals were recorded with a CCD camera (PCO-Sensicam, Kehlheim, Germany). Exposure time was 2000 ms.

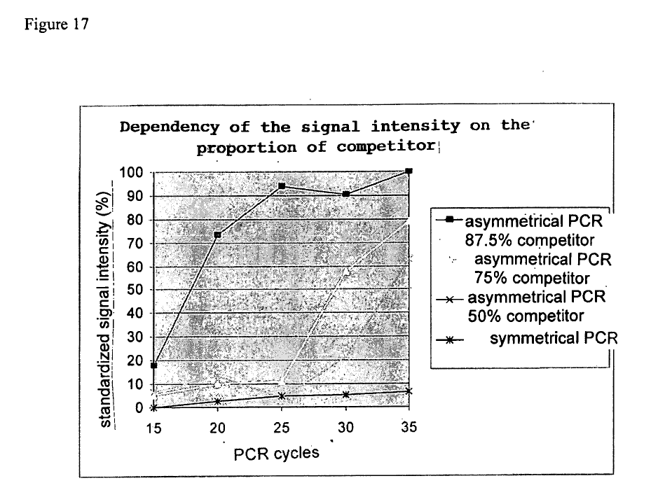

The intensity of hybridization signals was measured by averaging the signal strength (measured shade of gray) over the entire region of the spots. The shade of gray value averaged over the spot-free region (background) was subtracted from this value. The signal intensities thus calculated were standardized (highest value=100%) and plotted against the number of cycles (FIG. 17).

Results:

FIG. 17 shows that a stronger hybridization signal is achieved by means of PCR products from asymmetrical PCR reactions over the entire examined range of 15 to 35 cycles, although gel analysis (FIG. 16) showed a smaller amount of product for these reactions, in particular after 15 and 20 cycles.

The strongest signal was surprisingly achieved with the highest proportion of competitor, although herein the smallest amount of single-stranded target molecules was present. Hybridization of PCR products produced by means of asymmetrical PCR with varying proportion of competitor therefore showed a hybridization signal up to 20 times higher over the entire measurable range of amplification.

### Example 3

Detection of the Formation of a Single Strand Excess in Asymmetrical PCR

Two PCR setups (150 μl each) having the following composition and final concentrations were prepared.

The forward and the reverse primer as well as the competitor had the same sequences as in Example 1. However, the forward primer was labeled with the fluorescent dye IRD 800 at its 5′-end.

Both reactions contained:

1×PCR reaction buffer (Eppendorf Hamburg, Germany)

200 nM forward primer 16sfD11RD, labeled with the fluorescent dye IRD 800 (MWG-Biotech, Ebersberg, Germany) at its 5′-end

160 μM dNTPs

0.1 U/μl Taq polymerase (Eppendorf Hamburg, Germany)

2 ng/μl chromosomal DNA Corynebacterium glutamicum ATCC 13032

additional contents were:

Reaction 1: 200 nM reverse primer 16s Ra, no competitor (symmetrical PCR)

Reaction 2: 20 nM reverse primer 16s Ra

180 μM competitor 16s Ra 3′ NH2 (corresponding to 90% competitor, asymmetrical PCR)

The reactions were divided into 6 aliquots of 25 μl each (1/a -1/f and 2/a -2/f, respectively) and incubated according to the following temperature protocol:

| | | | |
|---|---|---|---|
| Initial denaturation | 2 | min | 95° C. |
| 35 cycles | 30 | sec | 95° C. |
| | 30 | sec | 50-70° C. |
| corresponds for: | | | |
| Reaction a: | | | 50° C. |
| Reaction b: | | | 54° C. |
| Reaction c: | | | 60° C. |
| Reaction d: | | | 63° C. |
| Reaction e: | | | 67° C. |
| Reaction f: | | | 70° C. |
| | 30 | sec | 72° |
| Terminal extension | 7 | min | 72° C. |

The annealing temperatures for reactions e and f were selected in such a way that annealing of the competitor and the reverse primer was not to take place, as they were higher than the melting temperatures of these oligonucleotides.

In each case, 2 μl of a 1:10 dilution of each aliquot were analyzed on a 3.5% native polyacrylamide gel in a LICOR sequencer (model, company). The gel had a thickness of 1 mm. Electrophoresis was performed with a limitation of voltage to 200 V and a limitation of power to 5 W. The gel was neither actively heated nor actively cooled (the control variable for temperature was set at 15° C.).

Data recording was performed at a depth of 16 bit, scan speed 1 and signal filter 3.

During PCR amplification, only one of the two strands is labeled with the IRD dye. Only said strand is visible in gel analysis in the LICOR sequencer. As a native gel was used, the PCR products are separated not only according to length, but also according to structural properties.

Results:

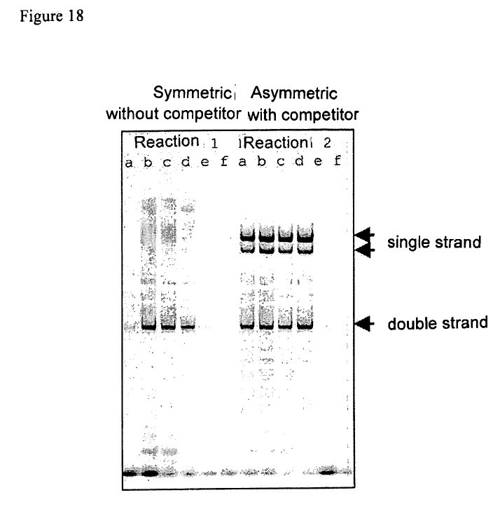

The results are shown in FIG. 18. As expected, only one dominating product is detected for all reactions in which amplification took place in gel analysis of the symmetrical reactions. This is the double-stranded PCR product. Contrarily to this, three dominating products are detected in all detectable asymmetrical reactions. Two further bands corresponding to different structures of the labeled single strand are obtained beside the double-stranded template. Therefore, gel analysis shows that asymmetrical amplification leads to a single strand excess.

### Example 4

Increasing the Hybridization Signal by Adding Secondary Structure Breakers

An asymmetrical multiplex PCR reaction was performed, which had the following composition and final concentrations. Genomic DNA, which contained the human cyp2D6 gene and whose genotype was known, was used as template:

1 μl cyp2D6 fusion primer mix consisting of:

0.5 μM uniA_cyp2D6_1/2f
(5′GGAGCACGCTATCCCGTTAGACCAGAGGAGCCCATTTGGTAGTGAGG
CAGGT3′)
1 μM uniA_cyp2D6_1/2f_F2
(5′GGAGCACGCTATCCCGTTAGACTGGACGCCGGTGGTCGTGCTCAA3′
)
1.5 μM uniA_cyp2D6_3/4f
(5′GGAGCACGCTATCCCGTTAGACCACGCGCACGTGCCCGTCCCA3′)
1 μM uniA_cyp2D6_5/6f_kF
(5′GGAGCACGCTATCCCGTTAGACCGCTGGCTGGCAAGGTCCTACG
C3′)
0.8 μM uniA_cyp2D6_8/9f_kF
(5′GGAGCACGCTATCCCGTTAGACGCCCCGGCCCAGCCACCAT3′)
1 μM uniB_cyp2D6_1/2r
(5′CGCTGCCAACTACCGCACATGGGTCCCACGGAAATCTGTCTCTGT3′
)
0.5 μM uniB_cyp2D6_1/2r_F1
(5′CGCTGCCAACTACCGCACATGCCTCTGCCGCCCTCCAGGACCTC3′)
1.5 μM uniB_cyp2D6_3/4r
(5′CGCTGCCAACTACCGCACATGCTCTCGCTCCGCACCTCGCGCAGA3′
)
1 μM uniB_cyp2D6_5/6r
(5′CGCTGCCAACTACCGCACATGCCCTCGGCCCCTGCACTGTTTCCCAG
A3′)
0.8 μM uniB_cyp2D6_8/9r_kF
(5′CGCTGCCAACTACCGCACATGTGGCTAGGGAGCAGGCTGGGGACT3′
)

200 μM dNTPs

1× Advantage PCR reaction buffer (Clontech, Palo Alto, USA)

0.1 U/μl Advantage DNA polymerase (Clontech, Palo Alto, USA)

1 μl human DNA sample KDL 36 (0.71 μg/μl) (Urs Meyer, Biozentrum Basel, Switzerland) genotype: homozygous cyp2D6 C2938T

The total volume of the PCR was 25 μl. In the now following first phase of the two-phase amplification reaction, incubation was performed under the following conditions:

| | | |
|---|---|---|
| Initial denaturation: | 95° C. | 10 min |
| 25 cycles: | 95° C. | 35 sec |
| | 65° C. | 50 sec |
| | 72° C. | 70 sec |
| Cooling down to 4° C. | | |

During the course of the reaction, the primers were used up and all fragments of the multiplex PCR were amplified to a uniform molar level. In this first phase, amplification was performed with primers, whose 3′-end had specificity for the target fragments and whose 5′-ends, however, had a uniform sequence for all forward primers and for all reverse primers.

In the now following second phase of the reaction, primers complementary to the uniform sequences were added. Simultaneously, a competitor was added having the same sequence as the now employed reverse primer, but having a NH₂ modification at the 3′-OH group at its 3′-end. Thus, the reaction in the second phase was performed asymmetrically.

The universal forward primer uniB had the following sequence and was labeled with a Cy3 group at its 5′-end:

5′-GGAGCACGCTATCCCGTTAGAC-3′

The universal reverse primer uniA had the following sequence:

5′-CGCTGCCAACTACCGCACATG-3′

The second phase was started by adding 25 μl of the following reaction mixture:

240 nM primer uniA

560 nM competitor uniA 3′NH2

800 nM primer uniB 5′Cy3 (Amersham-Pharmacia, Freiburg, Germany)

1× Advantage PCR reaction buffer (Clontech, Palo Alto, USA)

0.4 U/μl Advantage DNA polymerase (Clontech, Palo Alto, USA)

400 μM dNTPs

The total volume of the PCR reaction was 25 μl. In the second phase, the reaction was incubated as follows:

| | | |
|---|---|---|
| Initial denaturation: | 95° C. | 30 sec |
| 20 cycles: | 95° C. | 35 sec |
| | 65° C. | 50 sec |
| | 72° C. | 90 sec |
| Terminal elongation: | 72° C. | 7 min |

Array Arrangement

A probe array was produced by means of in situ synthesis according to the micro wet printing method (Clondiag Chip Technologies). The array consisted of 1,024 probe elements of 64×64 μm in size. These spots represented two different oligonucleotides:

| | |
|---|---|
| C2938T | 5′ AATGATGAGAACCTGTGCATAGTGGTG 3′ |
| C2938 WT | 5′ AATGATGAGAACCTGCGCATAGTGGTG 3′ |

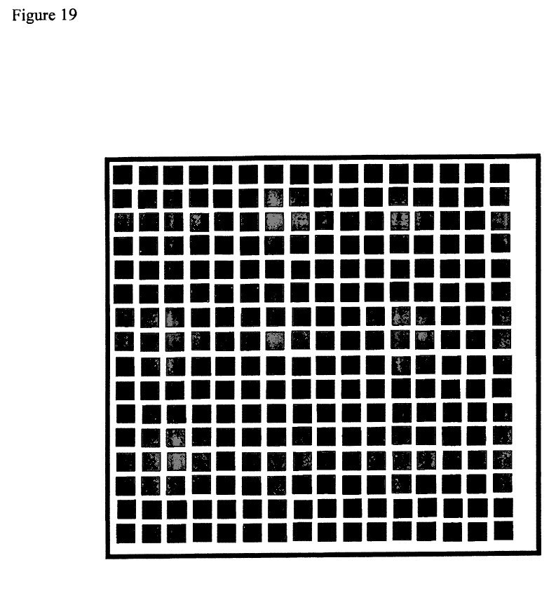

The probes were arranged according to the pattern depicted in FIG. 19. Black fields represent the probe C2938T, gray fields represent the probe C2938 WT.

Hybridization:

Five hybridization setups were prepared by taking up 5 μl of the multiplex PCR reactions in 60 μl SSPE, 0.1% SDS in each case. The structure breakers

| | |
|---|---|
| C2938TBL3 | (5′-GGCTGACCTGTTCTCTGCCG-3′) |
| and | |
| C2938TBL5 | (5′-GGAACCCTGAGAGCAGCTTC-3′) |

were added in different molar concentrations:

Reaction 1: no structure breakers

Reaction 2: 1.5 nM of each structure breaker

Reaction 3: 15 nM of each structure breaker

Reaction 4: 150 nM of each structure breaker

Reaction 5: 1.5 μM of each structure breaker

An array having the above-described layout was added to each reaction. The hybridization reactions were denatured for 5 min at 95° C. and subsequently incubated for 1 h at 50° C. Subsequently, three successive 5 min washing steps at 30° C. in 2×SSC, 0.1% SDS, at 30° C. in 2×SSC and at 20° C. in 0.2×SSC were performed. The chips were removed and subsequently vacuum dried.

Detection of the Hybridization Signals:

The detection of hybridization signals was performed under a Zeiss fluorescence microscope (Zeiss, Jena, Germany). Excitation was performed in incident light with a white light source and with a set of filters suitable for Cyanine 3. The signals were recorded with a CCD camera (PCO-Sensicam, Kehlheim, Germany). Exposure time was 5,000 ms.

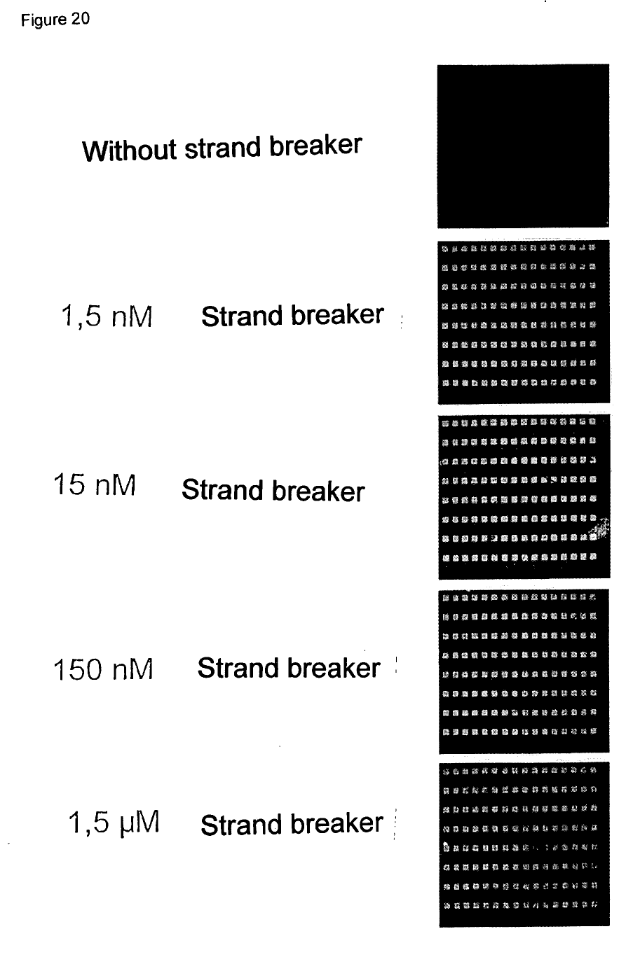

(FIG. 20)

Results:

Hybridization results exhibited the following pattern: The probes for the mutation C2938T exhibited strong signals, while the wild type probes and the deletion variants exhibited significantly lower signals. This corresponds to the expectations. It is noticeable that the signals are further enhanced by addition of the structure breakers. Therefore, a combination of competitor and secondary structure breaker is particularly useful for achieving good signal strengths.

### Example 5

Addition of a secondary structure breaker hybridizing in the proximity of sequence portions of the target, which are complementary to the probes.

An asymmetrical multiplex PCR reaction identical to the one in Example 4 was performed. Arrays having the same layout as in the preceding Example 4 were used.

Hybridization:

Four hybridization setups were prepared by means of taking up 5 μl of the multiplex PCR reactions in 60 μl SSPE, 0.1% SDS in each case. The hybridization setups differed with respect to the addition of the structure breakers

| | |
|---|---|
| C2938TBL3 | (5′-GGCTGACCTGTTCTCTGCCG-3′) |
| and | |
| C2938TBL5 | (5′-GGAACCCTGAGAGCAGCTTC-3′). |

Reaction 1: no structure breakers

Reaction 2: 1.5 μM structure breaker C2938TBL3

Reaction 3: 1.5 μM structure breaker C2938BL5

Reaction 4: 1.5 μM structure breaker C2938TBL3 and C2938TBL5 each

An array having the above-described layout was added to each reaction. Hybridization reactions were denatured for 5 min at 95° C. and subsequently incubated for 1 h at 50° C. Subsequently, three successive 5 min washing steps at 30° C. in 2×SSC, 0.1% SDS, at 30° C. in 2×SSC and at 20° C. in 0.2×SSC were performed. The chips were removed and subsequently vacuum dried.

Detection of Hybridization Signals:

Detection of the hybridization signals was performed under a Zeiss fluorescence microscope (Zeiss, Jena, Germany). Excitation was performed in incident light with a white light source and with a set of filters suitable for Cyanine 3. The signals were recorded with a CCD camera (PCO-Sensicam, Kehlheim, Germany). Exposure time was 10,000 ms.

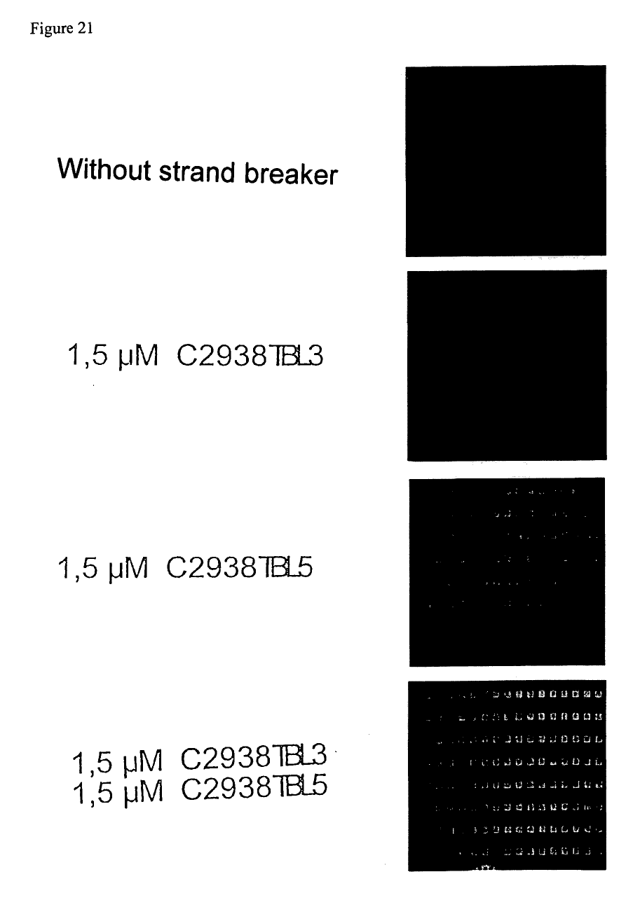

(FIG. 21).

Results:

Hybridization results exhibited the following pattern: The probes for the mutation C2938T exhibited strong signals, while the wild type probes and the deletion variants exhibited significantly lower signals. This corresponds to the expectations. It is noticeable that significantly higher signals are already achieved when adding one of the two structure breakers.

### Example 6

Influence of Structure Breakers on Match-Mismatch Discrimination

In the present example, secondary structure breakers are oligonucleotides binding near the actual hybridization probe in the hybridization of a double-stranded nucleic acid. Presumably, the double strand of the nucleic acid is disintegrated at the respective site and the binding capacity of the hybridization probe is improved. As shown in the following example, an enhancement of the hybridization signal by the factor 3 to 5 thus takes place without influencing the specificity of the reaction.

Preparation of the Array:

397 DNA probe arrays, each having 15 oligonucleotide probes of different sequence and length, were synthetically produced on an epoxidized glass wafer by Schott by means of the micro wet printing method (Clondiag Chip Technologies, Jena, Germany). All probes were complementary to a partial sequence of the exon 5/6 of the human cyp2D6 gene and differed only in the mid-region of the probe due to insertion of several different mutations.

Subsequently to synthesis, the wafer was sawed into chips of the size of 3.4×3.4 mm, wherein each of these chips contained a probe array with all 15 oligonucleotides in different redundancies. Altogether, each array consisted of 256 spots. These were arranged in 16 identical fields of 16 spots. The following sequences were set up in the individual spots.

| | |
|---|---|
| C2938T | AATGATGAGAACCTGTGCATAGTGGTG |
| C2938TC | AATGATGAGAACCTGTCGCATAGTGGTG |
| C2938GT | AATGATGAGAACCTGGTGCATAGTGGTG |
| C2938GTC | AATGATGAGAACCTGGTCGCATAGTGGTG |
| C2938G | AATGATGAGAACCTGGGCATAGTGGTG |
| C2938GC | AATGATGAGAACCTGGCGCATAGTGGTG |
| C2938d | AATGATGAGAACCTGGCATAGTGGTG |
| C2938CT | AATGATGAGAACCTGCTGCATAGTGGTG |
| C2938CTC | AATGATGAGAACCTGCTCGCATAGTGGTG |
| C2938 | AATGATGAGAACCTGCGCATAGTGGTG |
| C2938CC | AATGATGAGAACCTGCCGCATAGTGGTG |
| C2938AT | AATGATGAGAACCTGATGCATAGTGGTG |
| C2938ATC | AATGATGAGAACCTGATCGCATAGTGGTG |
| C2938A | AATGATGAGAACCTGAGCATAGTGGTG |
| C2938AC | AATGATGAGAACCTGACGCATAGTGGTG |

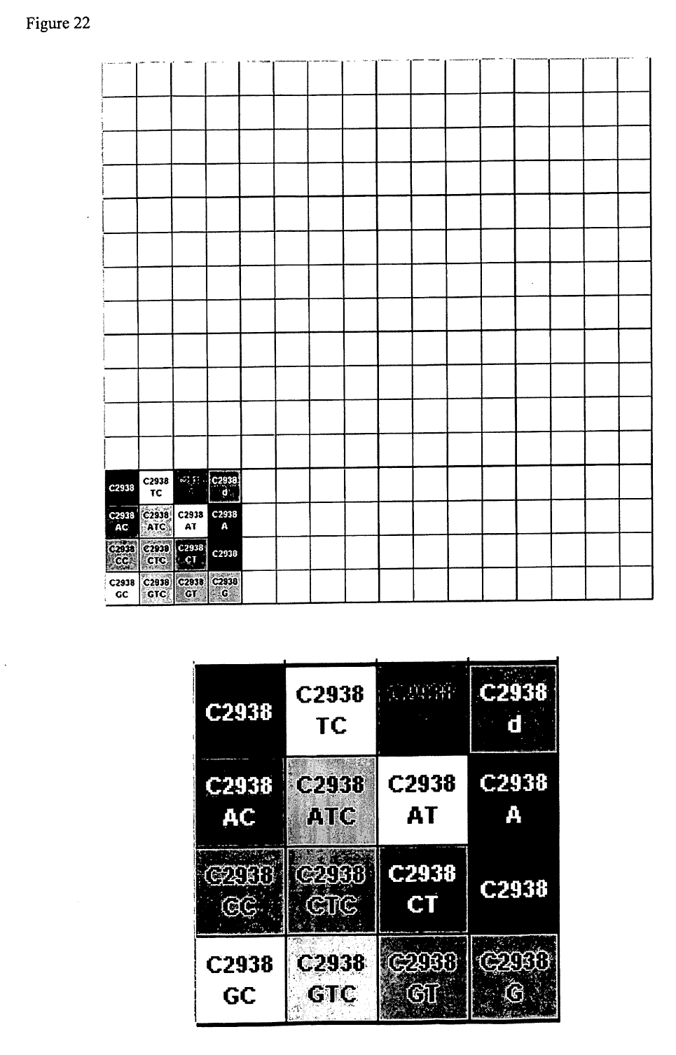

The arrangement of the probes on the array was performed as shown in FIG. 22. Each of the 16 thick-lined squares contained 16 array elements equipped with the probes shown for the square in the lower left portion of the illustration.

Preparation of the DNA Sample to be Hybridized:

In order to amplify the target for hybridization, an asymmetrical PCR was performed with a clinical DNA sample as template (KDL 31, kindly provided by Prof. U. Meyer, Biozentrum Basel, Switzerland). By means of the PCR, a partial sequence of the exon 5/6 of the human cyp2D6 gene was amplified. A competitor, the sequence of which was identical to the forward primer but was modified with an NH₂ group at the 3′-OH group at its 3′-end, was used in the PCR. The reverse primer was labeled with Cy3 at its 5′-end.

To this end, a PCR setup with the following final concentrations was prepared according to the following scheme:

| | |
|---|---|
| 20 nM | forward primer: cyp2D6_5/6f |

(5′GGACTCTGTACCTCCTATCCACGTCA3′)

| | |
|---|---|
| 180 nM | competitor: cyp2D6_5/6f_3NH2 |

(5′GGACTCTGTACCTCCTATCCACGTCA-NH₂-3′)

| | |
|---|---|
| 200 nM | reverse primer: cyp2D6_5/6r_5Cy3 |

(5′-Cy3-CCCTCGGCCCCTGCACTGTTTCCCAGA3′)

| | |
|---|---|
| 200 μM | dNTPs |

1× 10×Taq reaction buffer (Eppendorf AG, Hamburg, Germany)

5 U MasterTaq DNA polymerase (Eppendorf AG, Hamburg, Germany), 1 ng/μl template DNA (KDL 31), concentration 50 ng/μl)

The total volume of the PCR was 50 μl.

This setup was incubated according to the following temperature protocol:

| | | |
|---|---|---|
| Initial denaturation: | 10 min | 95° C. |
| 30 cycles: | 30 sec | 95° C. |
| | 50 sec | 62° C. |
| | 90 sec | 72° C. |
| Terminal elongation | 7 min | 72° C. |

The reaction products were purified on columns (PCR Purification Kit, Qiagen, Hilden, Germany) according to the manufacturer's protocol and subsequently quantified.

Hybridization:

In order to examine the influence of the secondary structure breakers on the hybridization, two different hybridization setups were performed: The corresponding secondary structure breakers were added to the first setup, the second setup served as control without secondary structure breakers.

To this end, the Cy3-labeled asymmetrical PCR was taken up in a final concentration of 25 nM in 50 μl 6×SSPE, 0.1% SDS. In addition, the structure breakers.

| | |
|---|---|
| 2938BL5 | (5′-GGAACCCTGAGAGCAGCTTC-3′) |
| and | |
| 2938BL3 | (5′-GGCTGACCTGTTCTCTGCCG-3′) |

were added to setup 1 in a final concentration of 1 μM each.

After addition of a chip to each hybridization setup, they were denatured for 5 min at 95° C. and then incubated for 1 h at 45° C. Subsequently, while being shaken, the chips were washed for 10 min at 30° C. in 2×SSC, 0.2% SDS, at 30° C. in 2×SSC and at 20° C. in 0.2×SSC (Sambrook et al., vide supra) and blow-dried by means of compressed air.

Detection of the Hybridization:

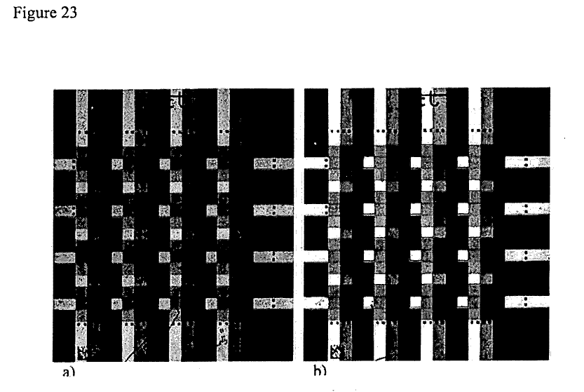

The hybridized and washed chips were read out in a slide scanner (Scanarray4000, GSI Lumonics). The chips were each recorded with a scanner setting offering a region as dynamic as possible given the existing signal intensity. In addition, a fluorescence standard (Fluoris®I, Clondiag Chip Technologies) was recorded with the selected measurement settings for later standardization of the data (FIG. 23).

Results:

The hybridization results are depicted in FIG. 23. FIG. 23a shows the fluorescence signals after hybridization of a PCR with the addition of structure breakers. The recording was made in the slide scanner with Laser-Power 70 and Photomultiplier 80. FIG. 23b, on the other hand, shows the negative control without addition of the respective structure breakers. The scanner settings were Laser-Power 100 and Photomultiplier 75. It is to be noted that FIG. 23b was thus recorded with a significantly higher laser and photomultiplier performance of the scanner. Therefore, the signals on this chip only appear to be stronger.

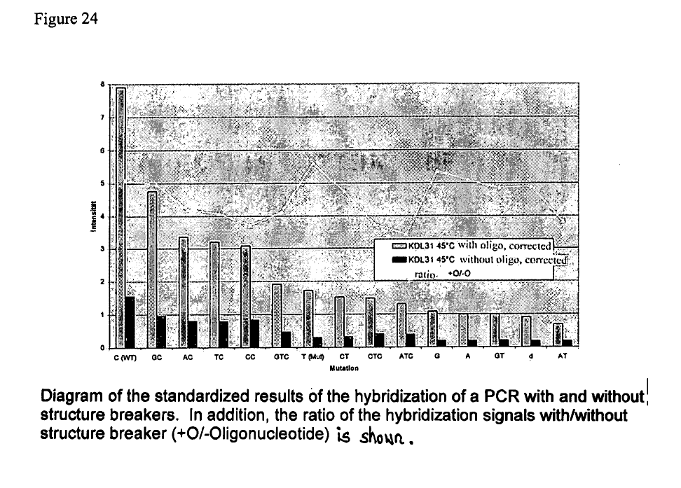

The recorded pictures were evaluated by means of the picture evaluation software Iconoclust® (Clondiag Chip Technologies) and obtained data were standardized by means of data from the fluorescence standard. The measuring values thus obtained are plotted in the diagram in FIG. 24.

In FIG. 24, it can be seen that the addition of structure breakers causes an increase of the fluorescence signal by the factor 3.5 to 5.5. As can be seen from the ratio of hybridization signals with and without secondary structure breaker oligonucleotide, the specificity of the hybridization, independently of the examined mutation, is not influenced within the scope of the margin of error.

### Example 7

Performance of a continuous asymmetrical PCR amplification and hybridization reaction with addition of structure breaker oligonucleotides at the beginning of the PCR reaction.

PCR Amplification and Hybridization

An asymmetrical Cy3-labeled PCR with a clinical DNA sample as template (KDL31, U. Meyer, Biozentrum Basel, Switzerland) served as target for the hybridization. The same forward and reverse primers as well as the same competitor as in Example 6 were used. Regarding the sequence, also the same structure breakers were used. However, they had an amino modification (NH₂ modification) at their 3′-end.

The PCR reaction setup had the following composition and final concentration:

| | |
|---|---|
| 70 nM | forward primer: cyp2D6_5/6f |
| | (5′-GGACTCTGTACCTCCTATCCACGTCA-3′) |
| 130 nM | competitor: cyp2D6_5/6f_3NH2 |
| | (5′-GGACTCTGTACCTCCTATCCACGTCA-NH₂-3′) |
| 200 nM | reverse primer: cyp2D6_5/6r_5Cy3 |
| | (5′-Cy3-CCCTCGGCCCCTGCACTGTTTCCCAGA-3′) |
| 20 nM | structure breaker 2938BL5 |
| | (5′GGAACCCTGAGAGCAGCTTC-NH₂-3′) |
| 20 nM | structure breaker 2938BL3 |
| | (5′GGCTGACCTGTTCTCTGCCG-NH₂-3′) |
| 200 μM | dNTPs |
| 1 × buffer | 10 × cDNA reaction buffer (Clontech, |
| | Palo Alto, USA), |
| 70 mM | K-acetate |
| 15 U | MasterTaq DNA polymerase (Eppendorf AG, |
| | Hamburg, Germany), |
| 1 ng/μl | template DNA (human genomic DNA KDL 31 |
| | (Urs Meyer, Biozentrum Basel, |
| | Switzerland) |

The volume of the PCR was 50 μl. A parallel setup had the identical composition regarding all components except the structure breaker oligonucleotides. The latter were not added.

Both setups were each provided with an array of the same layout as in Example 6 and were incubated according to the following temperature protocol:

| | | |
|---|---|---|
| Initial denaturation: | 10 min | 95° C. |
| 30 cycles: | 30 s | 95° C. |
| | 50 s | 62° C. |
| | 90 s | 72° C. |
| Terminal elongation: | 7 min | 72° C. |

Hybridization was performed as follows:

| | | |
|---|---|---|
| Denaturation: | 5 min | 95° C. |
| Hybridization: | 60 min | 40° C. |

Subsequently to hybridization the chips were washed while being shaken for 10 min at 30° C. in 2×SSC, 0.2% SDS, at 30° C. in 2×SSC and at 20° C. in 0.2×SSC (Sambrook et al., vide supra) and dried by means of compressed air.

Detection of the Hybridization and Evaluation

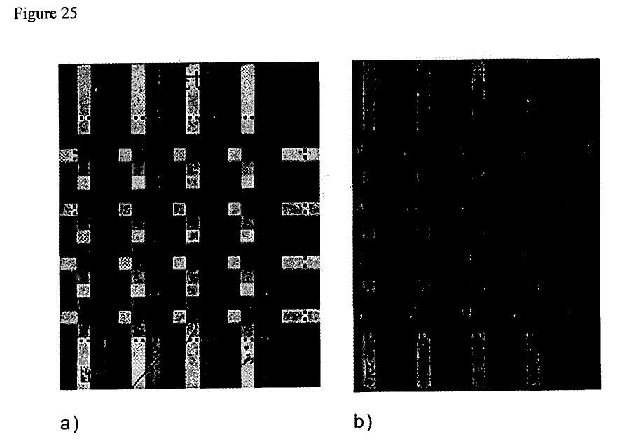

The hybridized and washed chips were read out in a slide scanner (Scanarray4000, GSI Lumonics). Both arrays were recorded with identical scanner settings (Laser-Power 70 and Photomultiplier 80). FIG. 25 (FIG. 25) shows the respective scanner pictures. FIG. 25a shows the fluorescence signals after hybridization of a PCR with addition of structure breakers; FIG. 25b, on the other hand, shows the reaction without addition of the respective structure breakers.

Results

It is becoming clear that the addition of structure breakers at the beginning of the PCR reaction had no negative influence on the result of the reaction. Rather, a more sensitive detection of hybridization signals was possible with the addition of the structure breaker oligonucleotides.

### Example 8

Comparison of asymmetrical and symmetrical amplification in a continuous PCR amplification and hybridization reaction.

A target sequence from Corynebacterium glutamicum was examined for the presence of insertions or deletions against a probe array and by means of hybridization.

Array

A DNA array was produced by means of site-specific in situ synthesis of oligonucleotides using micro wet printing (Clondiag Chip Technologies). Altogether, the array contained 64 array elements of a size of 256×256 μm. Each array element contained one of the following probes.

| | |
|---|---|
| Insertion: | 5′-GTTTCCCAGGGCTTATCCC-3′ |
| Deletion: | 5′-GTTTCCCAGCTTATCCC-3′ |
| Match: | 5′-GTTTCCCAGGCTTATCCC-3′ |

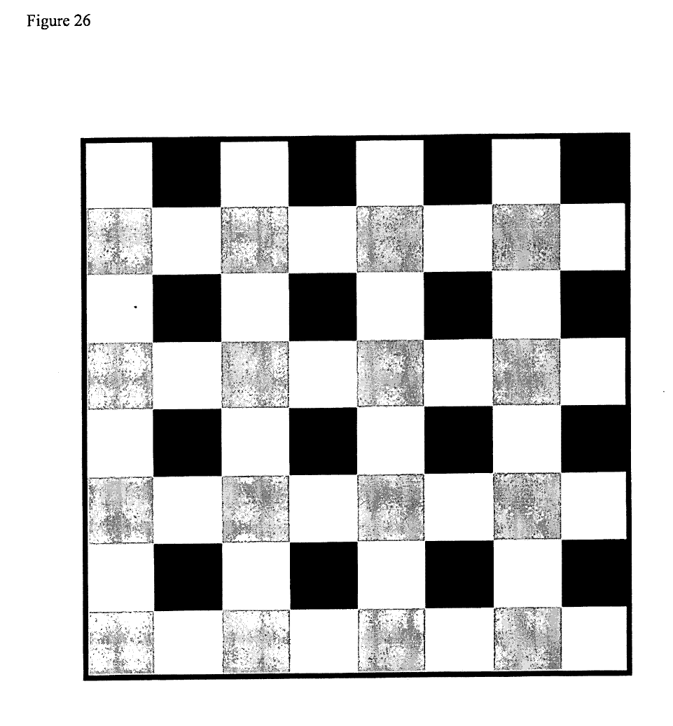

The correlation of the individual probes with the array elements is represented in FIG. 26 (FIG. 26). Array elements occupied by the match probe are depicted in white, probe elements occupied by the deletion probe are depicted in black, and probe elements occupied by the insertion probe are depicted in gray.

Continuous PCR and Hybridization Reaction

The forward primer 16sfD15′Cy3 had the following sequence and was labeled with the fluorescent dye Cy3 (Amersham-Pharmacia, Freiburg, Germany) at its 5′-end:

5′-AGAGTTTGATCCTGGCTCAG-3′

The reverse primer 16sRa and the competitor 16sRa3′NH₂ had the following sequence:

5′-TACCGTCACCATAAGGCTTCGTCCCTA-3′

At its 3′-end, the competitor had an amino modification (NH₂), which was integrated into the molecule during chemical synthesis of the oligonucleotide. Five symmetrical and five asymmetrical reaction setups of the following composition were prepared in each case. The concentrations of the Stock solutions are given in parentheses in each case.

Asymmetrical Reactions:

| | | |
|---|---|---|
| 0.5 | μl | reverse primer 16sRa (10 μM) |
| 1 | μl | c 16SRa3′NH₂ (10 μM) |
| 1.5 | μl | 16SfD15′Cy3 (10 μM) |
| 0.75 | μl | dNTP mixture (20 mM) |
| 0.75 | μl | chromosomal DNA Corynebacterium glutamicum (10 ng/μl) |
| 0.75 | μl | 10 × Clontech cDNA buffer |
| 54.5 | μl | PCR grade water |
| 3 | μl | Taq polymerase (Eppendorf, Hamburg, Germany) (5 U/μl) |
| 5 | μl | 1M potassium acetate |

Symmetrical Reactions:

| | | |
|---|---|---|
| 1.5 | μl | reverse primer 16SRa (10 μM) |
| 1.5 | μl | 16SfD15′Cy3 (10 μM) |
| 0.75 | μl | dNTP mixture (20 mM) |
| 0.75 | μl | chromosomal DNA Corynebacterium glutamicum (10 ng/μl) |
| 0.75 | μl | 10 × Clontech cDNA buffer |
| 54.5 | μl | PCR grade water |
| 3 | μl | Taq polymerase (Eppendorf, Hamburg, Germany) (5 U/μl) |
| 5 | μl | 1M potassium acetate |

In each case, one array was added to the reaction setups (in 0.2 ml PCR tubes). The reaction mixtures including the array were subjected to the following temperature protocol for PCR amplification and hybridization:

PCR:

| | | |
|---|---|---|
| Initial denaturation | 2 min | 95° C. |
| 10-30 PCR cycles | 30 sec | 95° C. |
| | 30 sec | 62° C. |
| Extension | 30 sec | 72° C. |

In each case, PCR amplification was terminated for a symmetrical and an asymmetrical reaction setup after 10, 15, 20, 25, and 30 cycles, respectively. Hybridization was performed immediately afterwards.

Hybridization:

| | | |
|---|---|---|
| Denaturation | 30 sec | 95° C. |
| Hybridization | 60 min | 42° C. |

Evaluation of the Hybridization

After completion of the hybridization, the arrays were washed once in 0.2×SSC for a short time at room temperature. After removing the liquid, the arrays were dried and read out in a fluorescence scanner (Scanarray4000, GSI Lumonics). The settings of laser and PMT varied depending on the intensity of the hybridization signals.

Results

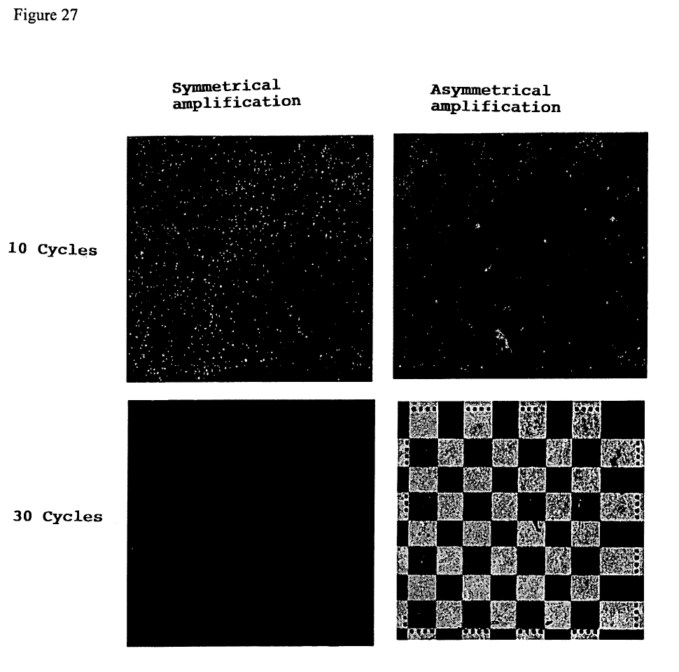

It turned out that the asymmetrical reaction always led to a stronger hybridization signal in comparison with the symmetrical reaction, no matter with how many cycles the amplification was performed. As an example, the hybridization signals of the reaction terminated after 10 and 30 cycles can be seen in FIG. 27 (FIG. 27).

### Example 9

PCR with Subsequent Hybridization in a 0.5 ml Standard Reaction Vessel (Eppendorf, Hamburg, Germany)

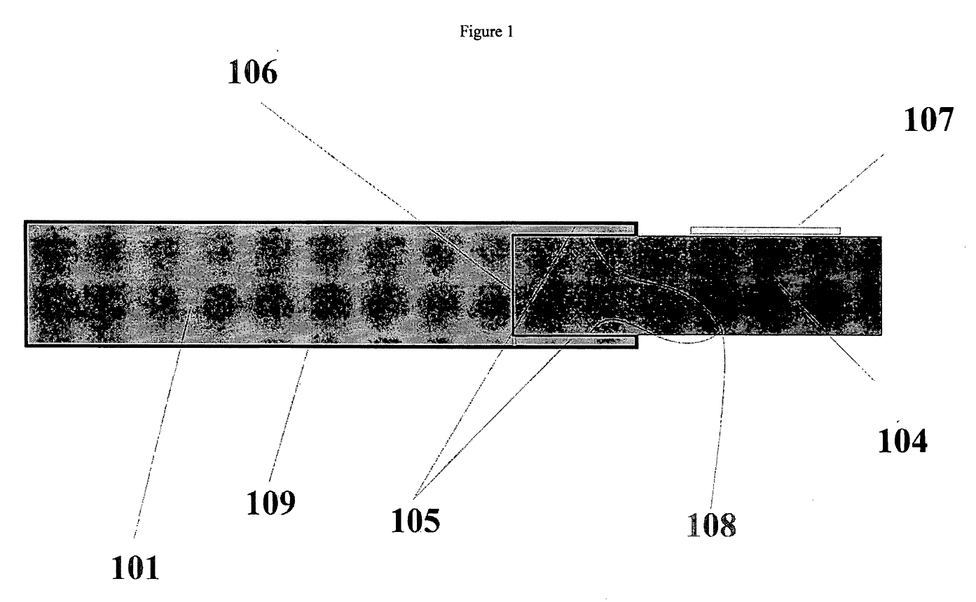

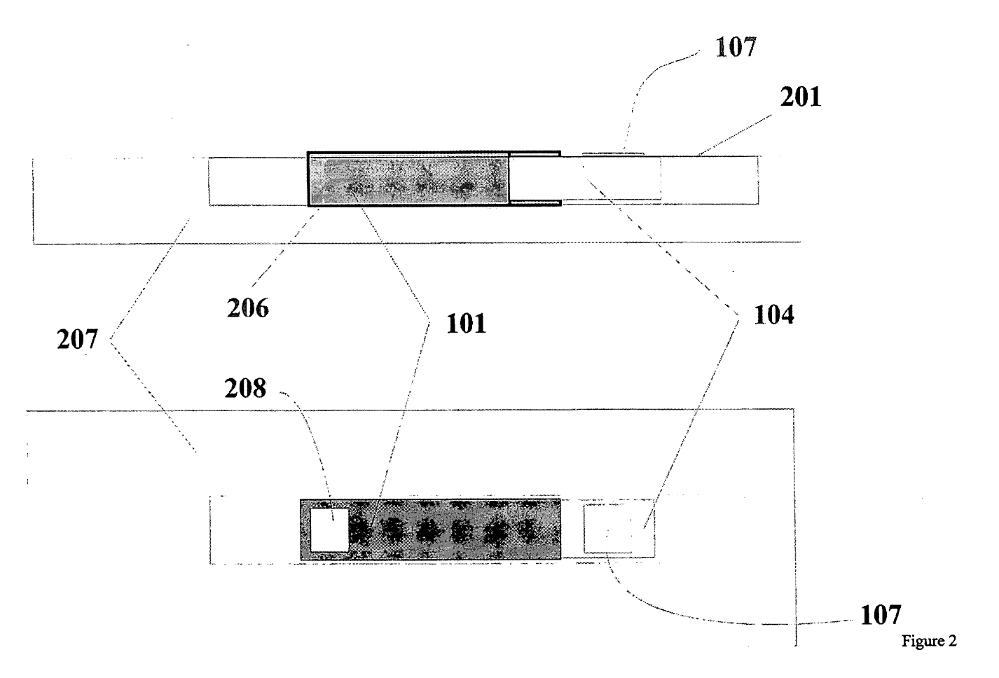

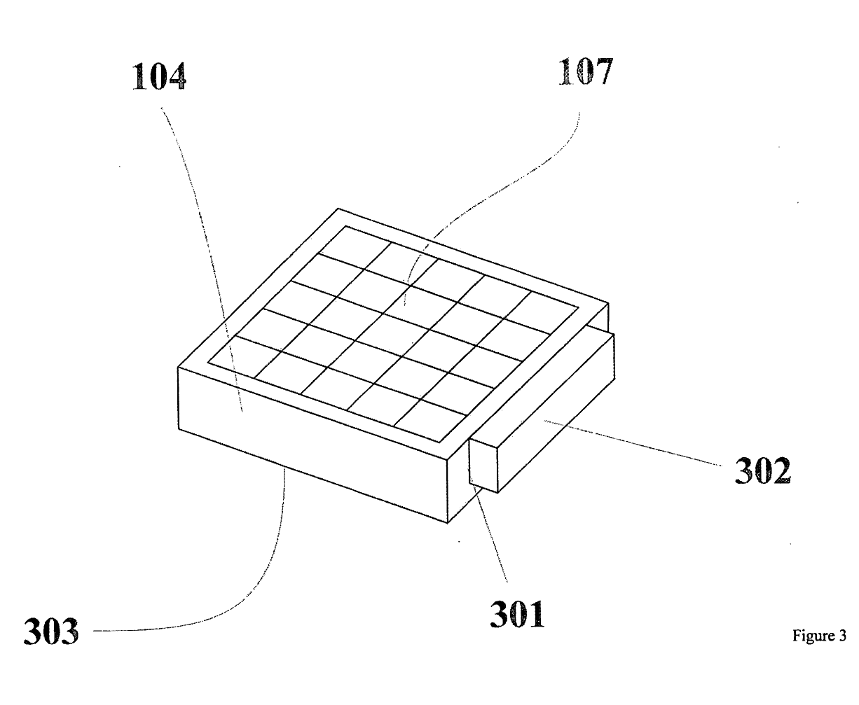

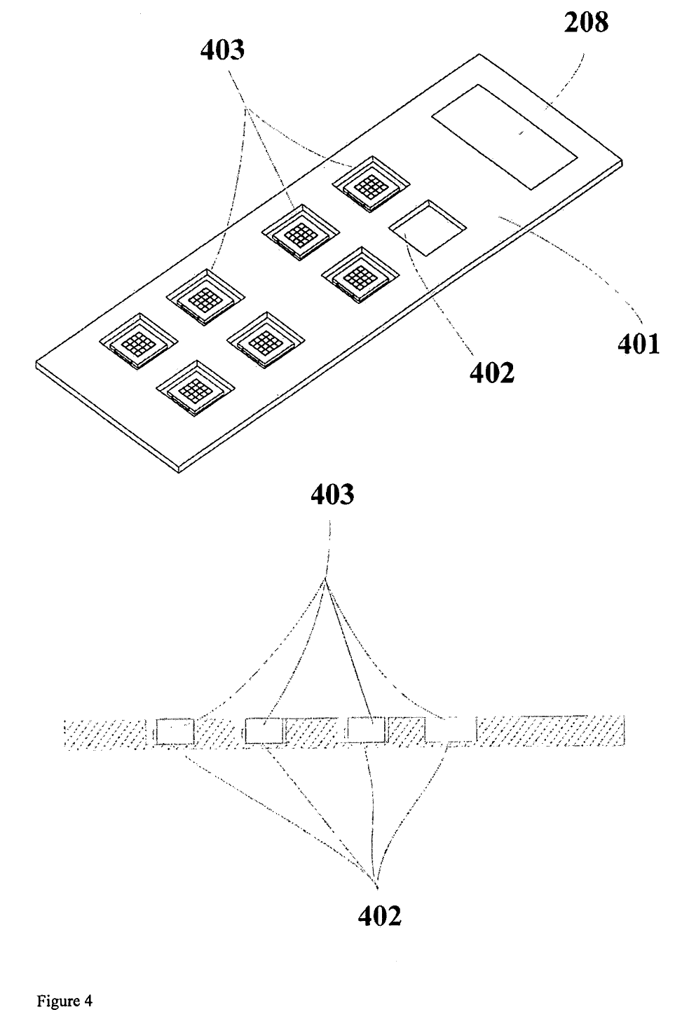

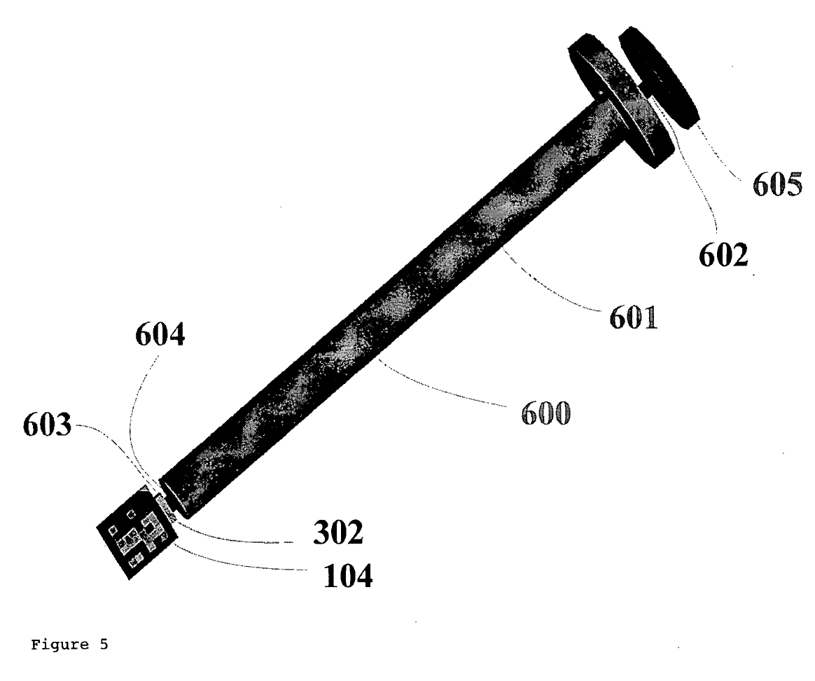

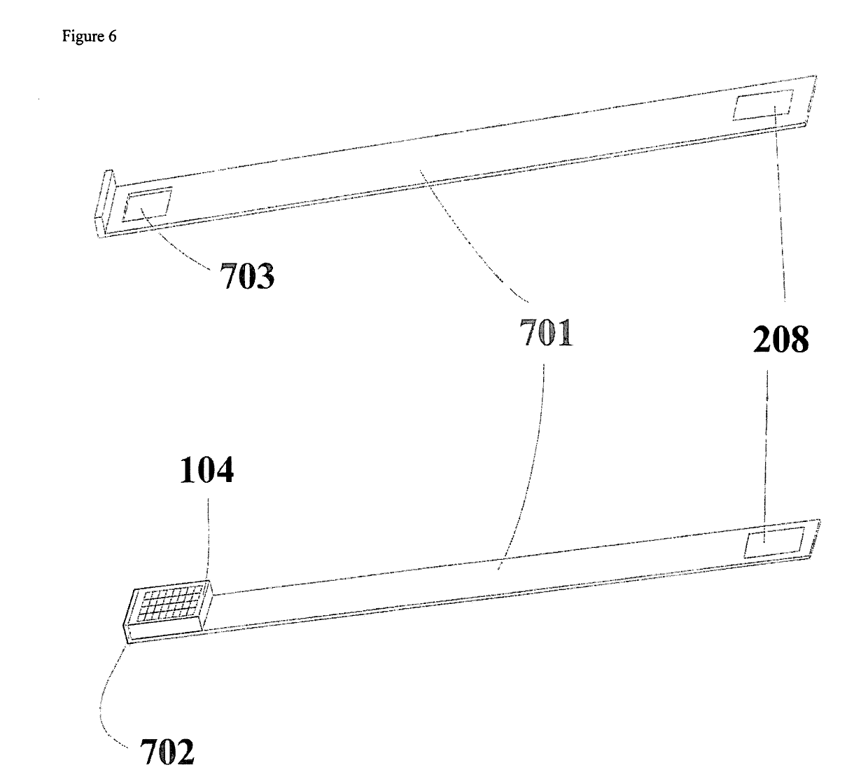

One holder (101, 302, 701) corresponding to FIGS. 1 to 7 was provided in each case. Furthermore, three 50 μl reaction setups for an asymmetrical PCR were prepared as follows:

| | | |
|---|---|---|
| 0.1 | μl | primer 1 16SRa (10 pmol/μl) |
| | | (5′TACCGTCACCATAAGGCTTCGTCCCTA3′) |
| 0.9 | μl | primer 2 16Ra3′NH₂ (10 pmol/μl) |
| | | (5′TACCGTCACCATAAGGCTTCGTCCCTA3′NH₂) |
| 1 | μl | primer 3 16SfD13′Cy3 (10 pmol/μl) |
| | | 5′AGAGTTTGATCCTGGCTCAG3′Cy3 |
| 1 | μl | DNA Polymerisation Mix 20 mM (5 mM of each |
| | | dNTP) (Abgene, Hamburg, Germany) |
| 5 | μl | Advantage 2 PCR buffer (Clontech, Palo |
| | | Alto, USA) |
| 1 | μl | genomic DNA from Corynebacterium |
| | | glutamicum (5 pg/μl) |
| 40.5 | μl | PCR grade water |
| 0.5 | μl | Taq polymerase 5 U/μl (Clontech, Paolo |
| | | Alta, USA) |

As negative control, a corresponding 50 μl reaction setup was prepared, but which contained no Taq polymerase.

The substance library carrier holders were each put into a reaction vessel and the vessel was closed.

PCR and hybridization reaction were performed in a Thermocycler Mastercycler Gradient (Eppendorf, Hamburg, Germany) according to the following protocol:

| | |
|---|---|
| 1) t = 95° C. 240 s | melting out of the genomic DNA |
| 2) t = 95° C. 30 s | cyclical regime for exponential |
| 3) t = 62° C. 30 s | amplification of the target DNA |
| 4) t = 72° C. 90 s | |
| 5) go to 2) repeat 30× | |
| 6) t = 50° C. 60 min | step for hybridizing the targets to the |
| | DNA array |

Subsequent to the reaction, the substance library carriers were subjected to a rinsing regime.

To this end, three times one 1.5 ml reaction vessel in each case was filled with 500 μl washing buffer 2×SSC+0.2% SDS and heated to 30° C. in a thermo shaker (Eppendorf, Hamburg, Germany). The substance library carriers were transferred from the PCR reaction vessels into the reaction vessels filled with washing buffer and shaken for 10 min at 300 l/min.

Subsequently, the same procedure was repeated with 500 μl washing buffer 0.2×SSC. The washing solution was removed from the reaction vessel by means of pipettes and the substance library carriers were subsequently dried in a Speedvac (Concentrator 5301, Eppendorf, Hamburg, Germany) in vacuum for 10 min at 30° C.

Detection of Hybridization Signals was Performed with the Aid of the Adapters (207, 401)
1) under a Zeiss fluorescence microscope (Zeiss): Excitation was performed in incident light with a white light source and with a set of filters suitable for Cyanine 3. Signals were recorded with a CCD camera (PCO-Sensicam, Kehlheim, Germany). Exposure time was 5,000 ms.
2) in a Scanarray 4000 confocal scanner (GSI Lumonics): Excitation was performed in incident light with a white light source and with a set of filters suitable for Cyanine 3.

In order to obtain detection of assured amplification, 5 μl of each reaction solution were additionally applied to a 2% agarose gel colored with ethidium bromite and separated for 30 min at a constant voltage of 220 V.

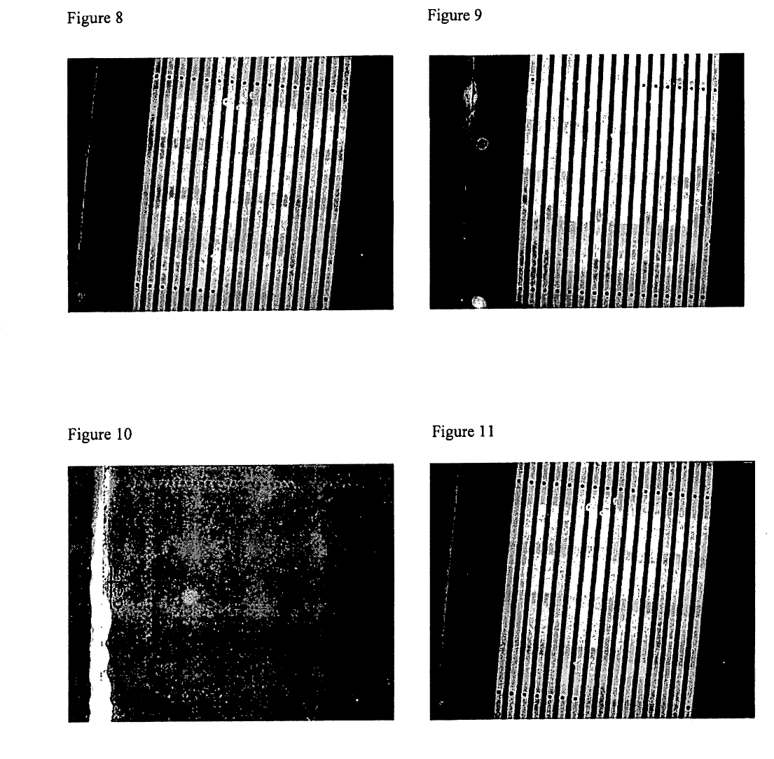

FIGS. 8 to 12 show:

FIG. 8: hybridization pattern, PCR with Taq polymerase (holder setup (101))

FIG. 9: hybridization pattern, PCR with Taq polymerase (holder setup (207))

FIG. 10: hybridization pattern, PCR without Taq polymerase (without holder)

FIG. 11: hybridization pattern, PCR with Taq polymerase (holder setup (401))

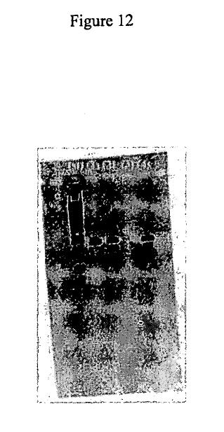

FIG. 12: gel image of the reaction solutions from the hybridization experiments

1. A holding device for substance libraries, comprising:
(i) a holder;
(ii) a substance library carrier which is fixed to the holder;
(iii) a detection area applied to the substance library carrier, on which said detection area a substance library is immobilized; and
wherein said substance library carrier can be introduced into a laboratory reaction vessel.

2. The holding device of claim 1, wherein said holder is introduced into said laboratory reaction vessel along with said substance library carrier.

3. The holding device of claim 1, further comprising said substance library carrier detachably fixed to said holder.

4. The holding device of claim 1, wherein said holder comprises an opening in vertical projection of a detection area to said holder.

5. The holding device of claim 4, wherein said holder further comprises an opening in which said substance library carrier engages.

6. The holding device of claim 5, wherein said substance library carrier comprises an upper side and a lower side and wherein said substance library carrier is gripped by at least one flange at said upper side or said lower side or a combination thereof.

7. The holding device of claim 6, wherein said substance library carrier is fixed to said holder by wedging said substance library carrier into said opening of said holder.

8. The holding device of claim 6, wherein said holder or said at least one flange, or a combination thereof, further comprises a material having a high linear extension coefficient.

9. The holding device of claim 8, wherein said material having a high linear extension coefficient is selected from the group consisting of phenyl methyl methacrylate, polycarbonate and combinations thereof.

10. The holding device of claim 1, wherein said substance library carrier is adhesively fixed to said holder.

11. The holding device of claim 1, wherein said substance library carrier is magnetically fixed to said holder.

12. The holding device of claim 1, further comprising:
a shaft having an upper end and a lower end;
wherein said holder comprises a hollow body adapted for receiving the shaft.

13. The holding device of claim 12, wherein said hollow body having a front face is a tube.

14. The holding device of claim 13, wherein said tube is circular.

15. The holding device of claim 12, wherein said shaft further comprises a handle at said upper end.

16. The holding device of claim 12, wherein said lower end of said shaft is magnetically coupled to the substance library carrier.

17. The holding device of claim 16, wherein said shaft is detached from said holder by pulling said shaft by the upper end out of said hollow body.

18. The holding device of claim 13, wherein said front face of said hollow body is magnetically designed.

19. The holding device of claim 18, wherein said substance library carrier is detached from said holder by pushing said shaft by the upper end into said hollow body.

20. The holding device of claim 1, further comprising a magnetically designed area opposite said detection area.

21. The holding device of claim 20, wherein regions of said magnetically designed area further comprise a non-magnetically designed area located within the vertical projection of said detection area.

22. The holding device of claim 1, wherein said holder comprises a non-fluorescent material.

23. The holding device of claim 1, wherein said holder comprises paper or plastic, or a combination thereof.

24. The holding device of claim 23, wherein said plastic is selected from the group consisting polypropylene, polyethylene and polycarbonate.

25. The holding device of claim 1, wherein said holder comprises a data matrix wherein said data matrix comprises information on the substance library and performance of detection reactions.

26. The holding device of claim 1, wherein said substance library is a protein library.

27. The holding device of claim 26, wherein said protein library is selected from the group consisting of an antibody library, a receptor protein library and a membrane protein library.

28. The holding device of claim 1, wherein said substance library is a peptide library.

29. The holding device of claim 28, wherein said peptide library is selected from the group consisting of a receptor ligand library, a library of pharmacologically active peptides and a library of peptide hormones.

30. The holding device of claim 1, wherein said substance library is a nucleic acid library.

31. The holding device of claim 30, wherein said nucleic acid library is a DNA molecule library.

32. The holding device of claim 30, wherein said substance library is an RNA molecule library.

33. The holding device of claim 1, wherein said substance library is immobilized on said substance library carrier in the form of a microarray.

34. A carrier system for detecting interactions between target molecules and substance libraries, comprising:
a) a holding device for substance libraries, comprising:
(i) a holder;
(ii) a substance library carrier which is fixed to said holder;
(iii) a detection area applied to the substance library carrier on which said detection area a substance library is immobilized; and
b) a detection adapter, to which at least one substance library carrier can be applied,
wherein said detection adapter has the external dimensions of a microscope object holder.

35. The carrier system of claim 34, wherein said holding device comprises:
(i) a holder;
(ii) a substance library carrier which is fixed to the holder;
(iii) a detection area applied to the substance library carrier, on which said detection area a substance library is immobilized; and
wherein said substance library carrier can be introduced into a laboratory reaction vessel.

36. The carrier system of claim 34, wherein said holder along with the substance library carrier is operable to be applied to said detection adapter.

37. The carrier system of claim 34, wherein said detection adapter comprises a recesses for receiving said holder or said substance library carrier or a combination thereof.

38. The carrier system of claim 34, wherein said holder, or the substance library carrier or a combination thereof is applied to said detection adapter in a detachable manner.

39. The carrier system of claim 34, wherein said detection adapter comprises a contact area for said holder or the substance library carrier or a combination thereof which is aligned parallel to said detection area.

40. The carrier system of claim 39, wherein said contact area is magnetically designed.

41. The carrier system of claim 40, wherein regions of said contact area located within the vertical projection of said detection area to said contact area are not designed magnetically.

42. The carrier system of claim 34, wherein said detection adapter comprises a non-fluorescent material.

43. The carrier system of claim 34, wherein said detection adapter comprises an optically transparent material.

44. The carrier system of claim 43, wherein said optically transparent material is selected from the group consisting of glass, borofloat, quarz glass, single crystal CaF₂, single crystal silicon, phenylmethyl methacrylate, polycarbonate, and combinations thereof.

45. The carrier system of claim 34, wherein said at least one substance library carrier comprises different geometric shapes.

46. Use of a device according to claim 1, for performing microarray-based tests.

47. Use of a device according to claim 1, for performing hybridization tests.

48. Use of a device according to claim 1, for performing a PCR, an LCR or an LDR.

49. Use of a device according to claim 1, for simultaneously performing a microarray-based test and a PCR.
